(19) United States
(12) Patent Application Publication
(10) Pub. No.: US 2026/0356652 A1
(43) Pub. Date: Nov. 12, 2026

(54) MULTI-SCREEN BEVERAGE DISPENSING NOZZLE WITH INTEGRATED ADDITIVE INJECTORS

(71) Applicant: HYDRATION LABS, INC., Charlestown, MA (US)

(72) Inventors: Adam Thomas Vigil, Somerville, MA (US); Louis Crisci, Medford, MA (US); Marshall Bronfin, Charlestown, MA (US)

(21) Appl. No.: 19/674,819

(22) Filed: May 12, 2026

Related U.S. Application Data
(60) Provisional application No. 63/944,231, filed on Dec. 18, 2025.
(60) Provisional application No. 63/804,234, filed on May 12, 2025.

(51) Int. Cl. B67D 1/00; B05B 7/26; G05D 7/01

(52) U.S. Cl. CPC B67D 1/0044; B05B 7/26; B67D 1/0041; G05D 7/0186

(57) ABSTRACT

A nozzle assembly for a beverage dispensing device is disclosed. The nozzle assembly can include a nozzle housing and a screen housing at least partially disposed within the nozzle housing. The nozzle housing can include a first inlet, and the screen housing can include a second inlet. Fluid entering at the first inlet can flow into or through one or more velocity reducing features and can exit from the nozzle assembly via a first outlet defined at least in part by a gap between the inner wall of the nozzle housing and the outer wall of the screen housing. Fluid entering at the second inlet can flow into or through one or more velocity reducing features, including a set of stacked screens each included apertures extending therethrough, and can exit from the nozzle assembly via a second outlet.

### CROSS-REFERENCE TO RELATED APPLICATIONS

This application claims priority to U.S. Provisional Application No. 63/804,234, filed on May 12, 2025, and entitled “Multi-Screen Beverage Dispensing Nozzle With Integrated Flavor Injectors,” and U.S. Provisional Application No. 63/944,231, filed on Dec. 18, 2025, and entitled “Multi-Screen Beverage Dispensing Nozzle With Integrated Flavor Injectors,” the contents of which are incorporated herein by reference in their respective entireties.

### TECHNICAL FIELD

Briefly described, the present disclosure relates generally to nozzles for beverage dispensing and beverage dispensing devices including such nozzles. More specifically, at least some aspects the present disclosure relate to multi-screen beverage dispensing nozzles, which can include and/or work in conjunction with one or more additive injectors (e.g., flavor injectors).

### BACKGROUND

Beverage dispensing machines, including those designed for countertop use, typically dispense fluids such as still water, carbonated water, and/or flavored beverages through a nozzle.

However, existing nozzles designs are often unable to adequately control the velocity of the dispensed liquids, resulting in an erratic and visually inconsistent stream. Indeed, fluids entering a nozzle at high velocity can produce turbulent, unpredictable flow, resulting in splashing and an aesthetically undesirable dispensing experience (e.g., the dispensed liquid flows out of the nozzle in spurts with repeated interruptions).

Additional challenge arise in multi-flavor beverage dispensers, where multiple liquid flavorings can be selectively injected into a base fluid stream. In such systems, residual flavoring remaining within a flavor injector after a dispensing event can drip into a subsequent dispensing event, contaminating the subsequent beverage with an unintended flavor. This cross-contamination problem can become compounded when multiple flavors share a common dispensing nozzle in close proximity to one another.

Moreover, conventional beverage dispensing systems—particularly multi-flavor beverage dispensing systems—have historically been designed for commercial or institutional settings, such as restaurants and convenience stores, where the size of the system’s physical footprint is not a primary design constraint. These systems typically rely on large, separate componentry for fluid velocity management and flavor injection (e.g., large mixing chambers, bulky valve assemblies, externally mounted flavor lines) that collectively result in a form factor incompatible with the space constraints of a household countertop appliance. As a result, existing systems are often usable only in commercial settings and are not readily translatable into small-scale and/or consumer-oriented devices (e.g., without significant compromise on functionality or performance, such as comparatively decreased dispensing performance and/or reduced flavor variety).

Therefore, there remains a long-felt and unsolved need for beverage dispensers and/or beverage dispenser nozzles that can provide a smooth, orderly stream of dispensed fluid; prevent cross-contamination between or among different flavor-specific components; and/or provide a compact form factor.

### BRIEF SUMMARY

These and other problems are addressed by the technology disclosed herein. The disclosed technology relates generally to a beverage dispenser nozzle. As a non-limiting example, the nozzle can include two or more screens. The screens can be arranged in a stacked and/or sequential configuration, such that fluid flowing through beverage dispenser can encounter one screen after the other. A given screen can include one or more plates, with each plate including one or more apertures. The plates can be made from and/or comprise plastic, metal, or any other useful material. By stacking two or more screens, the nozzle can lessen the velocity of fluid (e.g., water, flavors) flowing therethrough. And by slowing the flow of fluid via the stacked screens, the nozzle can produce an aesthetically pleasing and/or non-erratic stream of fluid. For example, the disclosed nozzle can produce streams of fluid exhibiting laminar flow.

The nozzle can include an eccentric chamber, which can be fluidly separated from at least one of the screens. The eccentric chamber can be shaped and/or dimensioned to lessen the velocity of a separate (e.g., second) fluid flow. The eccentric chamber can taper in size (e.g., width, from a largest size at or near an inlet to the eccentric chamber to a smallest size at the side of the eccentric chamber opposite from the inlet), thereby directing fluid flowing into the eccentric chamber into a plurality of ribs (e.g., vertical ribs). The plurality of ribs can reduce the fluid flow velocity and promote (e.g., direct) the fluid falling through a plurality of channels defined at least in part by the ribs, one or more outer surfaces of the screen housing, and/or one or more inner surfaces of the nozzle housing. By slowing fluid flow via the ribs, the nozzle can produce an aesthetically pleasing and/or non-erratic stream of fluid.

The nozzle can include a plurality of additive injectors (e.g., flavor injectors). A given additive injector can have a general elbow shape (e.g., having a bend, having an angle of less than 180°, having an acute angle, having an obtuse angle, having an approximately right angle). The elbow shaped additive injectors can be configured to reduce dripping and cross contamination of flavors or other additives (e.g., vitamins, minerals. compounds). The additive injectors can be manufactured from and/or comprise a low surface energy (LSE) material. As will be understood by one of ordinary skill in the art, LSE materials generally resist bonding, given LSE materials have a weak attraction for adhesives and other liquids. The LSE material (or other appropriate material) used for manufacturing the elbow shaped additive injector can reduce, or eliminate, residual flavoring and/or contamination within a length of the injector outlet (e.g., preventing a flavor from a previous dispensing event from remaining and potentially tainting a subsequent dispensing event intended to include a different flavor or omit flavors altogether).

The stacked, eccentric chamber, and/or additive injectors can be manufactured into a small form factor nozzle. The nozzle can be operatively configured to be installed into multi-additive (e.g., multi-flavor) beverage dispensers appropriate for household countertops (or similar locations). These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

The disclosed technology includes a beverage dispensing system comprising: a housing; a nozzle assembly; and one or more additive injectors. The nozzle assembly can be attached to the housing. The nozzle assembly can be in fluid communication with a first fluid source comprising a first fluid, a second fluid source comprising a second fluid, and one or more additive sources comprising one or more additives. The nozzle assembly can comprise a nozzle housing. The nozzle housing can comprise: a first outer wall at least partially defining an interior portion; and a first inlet in fluid communication with the interior portion and the first fluid source. The screen housing can be located at least partially within the interior portion. The screen housing can comprise: a second outer wall at least partially defining a chamber within the screen housing, the second outer wall having one or more outer wall surfaces distanced apart from one or more inner wall surfaces of the nozzle housing to thereby at least partially define one or more gaps; a second inlet in fluid communication with the chamber and the second fluid source; a first screen located at least partially within the chamber; and a second screen located at least partially within the chamber at a side of the first screen that is opposite from the second inlet. The one or more additive injectors can be in fluid communication with the one or more additive sources, and the one or more additive injectors can be configured to direct one or more additives toward a stream of the first fluid or the second fluid.

A first fluid flow path can be defined at least in part by the first inlet, the interior portion, and the one or more gaps. A second fluid flow path can be defined at least in part by the second inlet, the plurality of first apertures, and the plurality of second apertures. The second fluid flow path can be fluidly isolated from the first fluid flow path.

The beverage dispensing system can further comprise a fluid distribution system comprising one or more pumps configured to selectively direct the first fluid from the first fluid source to the first inlet, the second fluid from the second fluid source to the second inlet, and/or the one or more additives from the one or more additive sources to the one or more additive injectors.

The first fluid can be heated, and the second fluid can be unheated. Alternatively, the second fluid can be heated, and the first fluid can be unheated. Alternatively or in addition, both the first fluid and the second fluid can be heated (e.g., to the same or different temperatures). Alternatively or in addition, both the first fluid and the second fluid can be unheated. Alternatively or in addition, the first fluid and/or the second fluid can be chilled or cooled.

The second outer wall of the screen housing can extend outwardly from a bottom of the first outer wall of the nozzle housing.

The beverage dispensing system can further comprise a boot forming a first seal with the nozzle housing and a second seal with a nozzle aperture of the housing.

The disclosed technology can include a nozzle assembly comprising a first inlet, a second inlet, a nozzle housing, and a screen assembly. The nozzle housing can comprise a first outer wall defining an interior portion, the first inlet being in fluid communication with the interior portion; and an eccentric cavity having a concave wall as viewed from within the interior portion. The screen assembly can be disposed at least partially within the interior portion of the nozzle housing, and the screen assembly can comprise a screen housing having a second outer wall defining a chamber. The second inlet can be in fluid communication with the chamber. One or more outer surfaces of the second outer wall can be radially spaced apart from one or more inner surfaces of the interior portion to thereby provide one or more channels fluidly connected to a first outlet. The screen assembly can comprise a plurality of stacked screens, and at least some of the stacked screens can be at least partially disposed within the chamber. The plurality of screens can comprise a first screen and a second screen. The nozzle assembly can include a second outlet fluidly connected to the chamber.

The screen housing can comprise a chamber ceiling and a chamber inlet extending through the chamber ceiling. The chamber ceiling can have a first height at a perimeter of the chamber inlet and a second height at a position radially outward from the perimeter of the chamber inlet, and the second height can be greater than the first height. Alternatively or in addition, ever position radially outward from the perimeter of the chamber inlet can have a height that is greater than the first height. The chamber ceiling can taper from the first height to the second height. Alternatively or in addition, the chamber ceiling can taper from the first height to a plurality of heights (e.g., including the second height) that are each greater than the first height. The height of any particular point on or along the chamber ceiling can be defined as the distance between a base plane of the screen housing and a parallel plane intersecting the particular point on or along the chamber ceiling.

The first inlet can be in fluid communication with the eccentric cavity, the eccentric cavity can be in fluid communication with the one or more channels, and the one or more channels can be in fluid communication with the first outlet to thereby provide a first fluid flow path. The second inlet can be in fluid communication with the first plurality of apertures, the first plurality of apertures can be in fluid communication with the second plurality of apertures, and the second plurality of apertures can be in fluid communication with the second outlet to thereby provide a second fluid flow path. The second fluid flow path can be fluidly isolated from the first fluid flow path.

A bottom portion of the screen assembly can extend downwardly beyond a lowermost portion of the first outer wall of the nozzle housing.

The first outlet can have a generally annular shape. The first outlet can be defined at least in part by the lowermost portion of the first outer wall and an intermediate portion of the second outer wall.

The lowermost portion of the second outer wall can be configured to direct a first fluid from the first fluid flow path to flow off a lowermost, curved edge of the second outer wall after the first fluid exits the first outlet, thereby causing a flow of the first fluid to collapse centrally below the chamber of the screen housing.

The screen housing can comprise a plurality of ribs extending outwardly from the second outer wall. The plurality of ribs can at least partially define the one or more channels.

At least one of the one or more channels can have first width that is different from a second width of at least one other of the one or more channels.

The first inlet can be located at a first side of the nozzle assembly. At least some of the one or more channels having the first width can be located at a first side of the screen housing that corresponds to the first side of the nozzle assembly. At least some of the one or more channels having the second width can be located at a second side of the screen housing that is opposite from the first side of the screen housing. The second width can be greater than the first width. Alternatively, the first width can be greater than the second width.

The first inlet can be located at a first side of the nozzle housing. A first portion of the eccentric cavity can have a first radial width. The first portion of the eccentric cavity can be located at the first side of the nozzle housing. A second portion of the eccentric cavity can have a second radial width. The second portion of the eccentric cavity can be located at a second side of the nozzle housing that is opposite from the first side. The second radial width can be less than the first radial width.

The nozzle assembly can comprise a plurality of fins extending from the second screen. The plurality of fins can extend in a generally downward direction from the second screen.

At least some (e.g., each) fin of the plurality of fins can have a generally tapered profile.

At least some (e.g., each) fin of the plurality of fins can have a radially innermost point that is spaced apart from a central, generally vertical axis of the second screen.

The nozzle assembly can comprise a plurality of additive injectors. At least some (e.g., each) of the plurality of additive injectors can have a first injector portion extending from an injector inlet to a bend and a second injector portion extending from the bend to an injector outlet. At least some (e.g., each) of the plurality of additive injectors can be attached to the nozzle assembly such that the bend corresponds to an apex of an injector fluid path extending along the first injector portion and the second injector portion.

The disclosed technology can include a method comprising receiving one or more user inputs indicative of a fluid type selection and an additive type selection. The method can comprise, in response to the one or more user inputs indicating selection of a first fluid, directing the first fluid to flow through a first fluid path of a nozzle assembly. The first fluid path can comprise: an eccentric cavity located along a perimeter of an interior portion of a nozzle housing of the nozzle assembly; a plurality of ribs protruding radially outward toward the eccentric cavity and defining a plurality of channels extending at least partially in a vertical direction; the plurality of channels; and/or a first outlet. The first outlet can have a generally annular shape. The method can comprise, in response to the one or more user inputs indicated selection of a second fluid, directing the second fluid to flow through a second fluid path of the nozzle assembly. The second fluid path can comprise: an inlet channel extending through a generally vertical inlet stem; a generally annular cavity flow path defined at least in part by a longitudinal cavity and a longitudinal protrusion extending generally upward therein; a plurality of first apertures extending through a first body of a first screen; a plurality of second apertures extending through a second body of a second screen; and a second outlet located withing the generally annular shape of the first outlet; and directing one or more additives indicated by the one or more user inputs to inject into the first fluid as the first fluid exits the first outlet or into the second fluid as the second fluid exits the second outlet.

The method can comprise creating a reverse flow of the one or more additives to move at least some of the one or more additives away from one or more corresponding additive outlets and past a local apex of each of one or more corresponding additive flow paths.

### BRIEF DESCRIPTION OF FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates a perspective view of an example nozzle assembly, in accordance with the disclosed technology;

FIG. 2 illustrates a perspective view of a nozzle assembly, in accordance with the disclosed technology;

FIG. 3A illustrates a top perspective view of a nozzle assembly, in accordance with the disclosed technology;

FIG. 3B illustrates a front perspective view of an example nozzle assembly with a screen housing removed, in accordance with the disclosed technology;

FIG. 4 illustrates a cross-sectional view of an example nozzle assembly taken along a vertical plane, in accordance with the disclosed technology;

FIG. 5 illustrates a cross-sectional view of an example nozzle assembly taken along a horizontal plane , in accordance with the disclosed technology;

FIG. 6 illustrates a bottom perspective view of an example screen housing, in accordance with the disclosed technology;

FIG. 7A illustrates a perspective view of example screens, in accordance with the disclosed technology;

FIG. 7B illustrates a plan view of example screens, in accordance with the disclosed technology;

FIG. 8 illustrates a cross-sectional view of nozzle assembly and additive injector attached thereto, in accordance with the disclosed technology;

FIG. 9A illustrates a perspective view of an example nozzle assembly, in accordance with the disclosed technology;

FIG. 9B illustrates a front view of an example nozzle assembly, in accordance with the disclosed technology;

FIG. 9C illustrates a bottom view of an example nozzle assembly, in accordance with the disclosed technology;

FIG. 9D illustrates an exploded view of an example nozzle assembly, in accordance with the disclosed technology;

FIG. 9E illustrates a cross-sectional view of an example nozzle assembly, in accordance with the disclosed technology;

FIG. 10A illustrates a perspective view of an example nozzle housing, in accordance with the disclosed technology;

FIG. 10B illustrates a top view of an example nozzle housing, in accordance with the disclosed technology;

FIG. 10C illustrates a slightly angled top view of an example nozzle housing , in accordance with the disclosed technology;

FIG. 10D illustrates a side view of an example nozzle housing , in accordance with the disclosed technology;

FIG. 10E illustrates a cross-sectional view of an example nozzle housing, in accordance with the disclosed technology;

FIG. 11A illustrates a top perspective view of an example screen housing, in accordance with the disclosed technology;

FIG. 11B illustrates a bottom perspective view of an example screen housing, in accordance with the disclosed technology;

FIG. 11C illustrates a front view of an example screen housing, in accordance with the disclosed technology;

FIG. 11D illustrates a side view of an example screen housing, in accordance with the disclosed technology;

FIG. 11E illustrates a bottom view of an example screen housing, in accordance with the disclosed technology;

FIG. 11F illustrates a cross-sectional view of an example screen housing, in accordance with the disclosed technology;

FIG. 12 illustrates a cross-sectional view of an example screen assembly , in accordance with the disclosed technology;

FIG. 13A illustrates a top perspective view of two example screens, in accordance with the disclosed technology;

FIG. 13B illustrates a bottom perspective view of a first example screen, in accordance with the disclosed technology;

FIG. 13C illustrates a plan view of a first example screen, in accordance with the disclosed technology;

FIG. 13D illustrates a bottom perspective view of a second example screen, in accordance with the disclosed technology;

FIG. 13E illustrates a plan view of a second example screen, in accordance with the disclosed technology;

FIG. 14A illustrates a top perspective view of a first cross-section of an example nozzle assembly , in accordance with the disclosed technology;

FIG. 14B illustrates a top perspective view of a second cross-section of an example nozzle assembly , in accordance with the disclosed technology;

FIG. 14C illustrates a bottom view of an example nozzle assembly, in accordance with the disclosed technology;

FIG. 14D illustrates a front view of an example nozzle assembly, in accordance with the disclosed technology;

FIG. 15A–15C illustrate bottom views of an example nozzle assembly, in accordance with the disclosed technology;

FIG. 16 illustrates a bottom perspective view of a portion of an example beverage dispensing device, in accordance with the disclosed technology;

FIGS. 17A and 17B illustrate bottom views of an example nozzle assembly attached to an example boot of a beverage dispensing device, in accordance with the disclosed technology;

FIG. 17C illustrates a bottom perspective view of an example nozzle assembly attached to an example boot of a beverage dispensing device, in accordance with the disclosed technology;

FIG. 17D illustrates a side view of an example nozzle assembly attached to an example boot of a beverage dispensing device, in accordance with the disclosed technology;

FIG. 17E illustrates a perspective view of an internal portion of an example beverage dispensing device, in accordance with the disclosed technology;

FIG. 18A illustrates a perspective view of an internal portion of an example beverage dispensing device, in accordance with the disclosed technology;

FIG. 18B illustrates an enlarged perspective view of an example nozzle assembly attached to an example boot of a beverage dispensing device, in accordance with the disclosed technology; and

FIG. 19 illustrates a flowchart of an example beverage dispensing process, in accordance with the disclosed technology.

### DETAILED DESCRIPTION

The disclosed technology disclosure relates to nozzles for beverage dispensing. Specifically, the present disclosure relates to a multi-screen beverage dispensing nozzle with integrated additive injectors (e.g., flavor injectors). Some examples of the disclosed technology will be described more fully with reference to the accompanying drawings. However, this disclosed technology may be embodied in many different forms and should not be construed as limited to the implementations set forth herein. The components described hereinafter as making up various elements of the disclosed technology are intended to be illustrative and not restrictive. Indeed, it is to be understood that other examples are contemplated. Many suitable components that would perform the same or similar functions as components described herein are intended to be embraced within the scope of the disclosed electronic devices and methods. Such other components not described herein may include, but are not limited to, for example, components developed after development of the disclosed technology.

Throughout this disclosure, various aspects of the disclosed technology can be presented in a range of formats (e.g., a range of values). It should be understood that such descriptions are merely for convenience and brevity and should not be construed as an inflexible limitation on the scope of the disclosed technology. Accordingly, the description of a range should be considered to have specifically disclosed all the possible subranges as well as individual rational numerical values within that range. For example, a range described as being “from 1 to 6” or “from approximately 1 to approximately 6” includes the values 1, 6, and all values therebetween. Likewise, a range described as being “between 1 and 6” or “between approximately 1 and approximately 6” includes the values 1, 6, and all values therebetween. The same premise applies to any other language describing a range of values. That is to say, the ranges disclosed herein are inclusive of the respective endpoints, unless otherwise indicated.

Where specific values, measurements, or ranges are provided herein, the terms “approximately,” “about,” and similar terms of approximation are intended to encompass reasonable variations from the stated value or range that would be recognized by one of ordinary skill in the art as producing substantially the same result or function. Unless otherwise indicated, such terms of approximation shall be understood to permit a variation of up to 10% from the stated value in either direction, though the permissible degree of variation may be greater or lesser depending on the context and the nature of the value being approximated. For example, a stated angle, dimension, material property, or other measurable characteristic preceded by a term of approximation is not intended to be strictly limited to the precise value recited, but rather encompasses values within a reasonable tolerance thereof as would be understood by one of ordinary skill in the relevant art. The use of such terms of approximation is not intended to limit the scope of the claims, and the absence of such a term with respect to any particular value should not be construed to mean that the value is intended to be exact and absolute (unless otherwise indicated herein).

The use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicates that different instances of like objects are being referred to and are not intended to imply that the objects so described should be in a given sequence, either temporally, spatially, in ranking, or in any other manner.

Whether or not a term is capitalized is not considered definitive or limiting of the meaning of a term. As used in this document, a capitalized term have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

For the purpose of promoting an understanding of the principles of the present disclosure, reference will now be made to the illustrative examples provided in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

### Overview

Briefly described, the present disclosure relates to nozzles for beverage dispensing. Specifically, various aspects of the present disclosure relate to a multi-screen beverage dispensing nozzle with integrated additive injectors.

The disclosed technology includes a beverage dispenser nozzle (also referenced herein as a “nozzle assembly”). The nozzle can include two or more screens, and the screens can be arranged in a stacked configuration, as a non-limiting example. The screens (e.g., stacked screens) can lessen the velocity of fluid (e.g., water, flavors, additives) flowing through the nozzle. By slowing fluid flow via the screens, the nozzle can produce an aesthetically pleasing and/or non-erratic stream of fluid. Alternatively or in addition, the nozzle can produce a stream of fluid exhibiting laminar flow.

The nozzle can include a separate eccentric chamber in which the velocity of a separate fluid flow can be reduced. The eccentric chamber can taper in width, thereby directing fluid flowing into the eccentric chamber into a plurality of ribs (e.g., vertical ribs). The ribs can reduce the fluid flow velocity and can direct the fluid through a plurality of channels (e.g., channels extending in an at least partially vertical direction) that are at least partially defined by the ribs. By slowing fluid flow via the ribs, the nozzle can produce an aesthetically pleasing and/or non-erratic stream of fluid.

The nozzle can include a plurality of additive injectors. One or more of the additive injectors can have a general elbow shape. Alternatively or in addition, the additive injectors can be configured to reduce dripping and/or cross contamination of flavors or other additives. The additive injectors can be manufactured from and/or comprise a low surface energy (LSE) material. As will be understood by one of ordinary skill in the art, LSE materials generally resist bonding, given LSE materials have a weak attraction for adhesives and other liquids. The LSE material (or other appropriate material) included in the additive injector(s) can reduce, or eliminate, residual flavoring within a length of the injector outlet(s) of the additive injector(s).

The stacked screens, eccentric chamber, and/or additive injectors can be manufactured into a small formfactor nozzle. The nozzle can be operatively configured to be installed into multi-additive (e.g., multi-flavor) beverage dispensers appropriate for household countertops (and similar locations).

### Example Embodiments

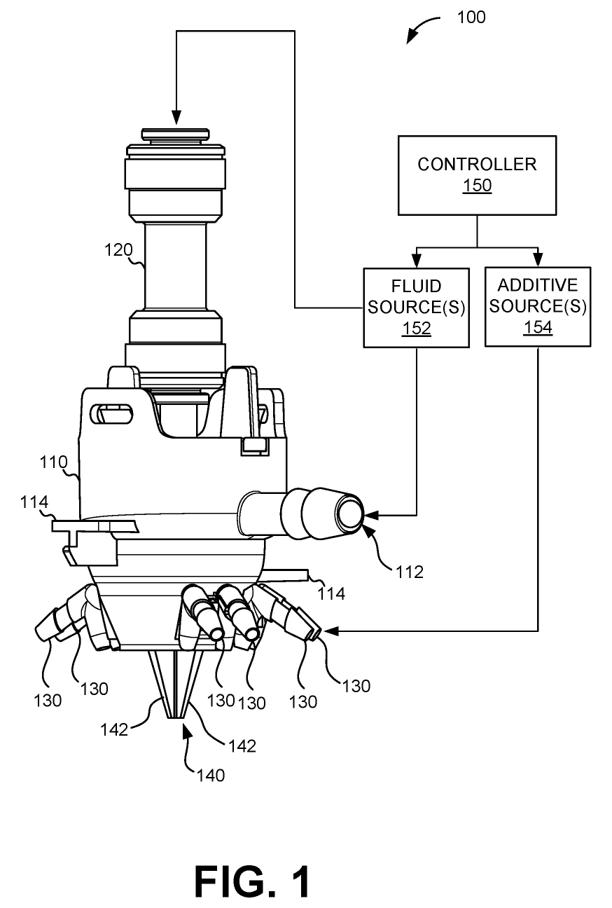

Referring now to FIG. 1, an example nozzle (generally referenced herein as the nozzle assembly 100) is shown. The nozzle assembly100 can include a nozzle housing 110. The nozzle housing 110 can be or include a casing, shell, body, or the like, which can at least partially enclose or envelop one or more components of the nozzle assembly 100 and/or to which one or more components of the nozzle assembly 100 can be attached. The nozzle assembly 100 can include one or more fluid inlets (e.g., a first inlet 112 and/or a second inlet 213) and/or a dispensing outlet 113. Alternatively or in addition, the nozzle assembly 100 can include one or more additive injectors 130 (e.g., for introducing one or more additives to fluid received from the one or more fluid inlets), as described more fully herein.

The nozzle assembly 100, any portion thereof, and/or any associated components can be manufactured from a variety of materials (e.g., comprise one or more materials). For example, the nozzle assembly 100, its components, and/or any portion(s) thereof can be manufactured from and/or comprise one or more plastics, one or more thermoplastics, one or more metals, and/or generally any material suitable for use in a beverage dispensing machine. The nozzle housing 110 can be configured to be securely positioned within a beverage dispensing machine. The nozzle housing 110 can include one or more components for receiving one or more fluids. For example, the nozzle housing 110 can include a first inlet 112 and/or a second inlet 213. As a non-limiting example, the first inlet 112 can be a hot fluid inlet, and the second inlet 213 can be a cold fluid inlet. Alternatively, the first inlet 112 can be a cold fluid inlet, and the second inlet 213 can be a hot fluid inlet.

As illustrated, the first inlet 112 can extend (and/or protrude) outwardly (e.g., at least partially horizontally) from the nozzle housing 110. As shown, the first inlet 112 can extend outwardly from the nozzle housing 110. Alternatively or in addition, the first inlet 112 can include one or more barbs for securely connecting the first inlet 112 to a hose, piping, or similar plumbing material. Although not shown, the first inlet 112 can be securely connected (or securely connectable) to a hose through which fluid (e.g., hot fluid) can be received. Alternatively or in addition, the first inlet 112 can be configured to fluidly connect to one or more fluid sources 152 (e.g., a cold fluid source, a cold water source, a hot fluid source, a hot water source, a still fluid source, a carbonated fluid source) via one or more different features, mechanisms, or the like (e.g., via a fitting 120 as shown and described with respect to the second inlet 213).

The nozzle housing 110 can include, or be in fluid communication with, a fitting 120. The fitting 120 can be or include any type of connector or the like, such as a push-fit tube fitting, which can include a push-to-connect fitting (e.g., as manufactured by John Guest). A lower end of the fitting 120 can be configured to securely connect to a second inlet 213 of the nozzle assembly 100, and an upper end of the fitting 120 can be configured to securely connect to a pipe or similar tubing. The fitting 120 can fluidly connect the nozzle assembly 100 to one or more fluid sources 152, such as a cold fluid source (e.g., a source of cold water) or a hot fluid source (e.g., a source of hot water). For example, the fitting 120 can connect the nozzle assembly 100 to still and/or carbonated fluid sources 152. Alternatively or in addition, the nozzle assembly 100 can connect to one or more fluid sources 152 via one or more different features, mechanisms, or the like (e.g., alternatively or in addition to the fitting 120), such as one or more barbs (e.g., as illustrated with respect to the first inlet 112). As will be discussed in more detail below, the fitting 120 can be configured to securely connect to an inlet stem 212 through which fluid (e.g., cold, still, carbonated) can be received from the one or more corresponding fluid sources 152.

The nozzle assembly 100 can include a flow stabilizer 140 located at or near (e.g., immediately below) the dispensing outlet 213. The flow stabilizer 140 can be configured to promote a downward laminar flow of fluid exiting the dispensing outlet 113. The flow stabilizer 140 can be attached to, or integral with, the nozzle housing 110, as a non-limiting example. Alternatively or in addition, the flow stabilizer can be attached to, or integral with, one or more other components of the nozzle assembly l100 (such as the screen housing 210 or the one or more screens 310, 410, which are discussed in more detail elsewhere herein). The flow stabilizer 140 can include one or more fins 142 (e.g., a plurality of fins 142), and the fins 142 can be spaced apart and/or circumferentially arranged along an external wall of the body (e.g., a central portion) of the flow stabilizer 140. At least some of the fins have a generally triangular cross-sectional shape. As a non-limiting example, a given fin 142 can have a width that is greater at or near an upper end (e.g., at the uppermost end) of the fin 142 than a width at or near the lower end (e.g., at the lowermost end) of the fin 142. Stated differently, a given fin 142 can taper to a point at which a stream of fluid disengages from and exits (e.g., comes out of contact with) the nozzle assembly 100. Each fin 142 can have the same shape and/or dimension. Alternatively or in addition, one or more fins 142 can have a size and/or shape that is different from one or more other fins 142. Regardless, the flow stabilizer 140 can help the nozzle assembly 100 to produce a downward stream of fluid that can exhibit laminar flow due (e.g., owing to one or more flow manipulation techniques performed on or to the fluid by flow stabilizer 140 and/or other components of the nozzle assembly 100).

The nozzle housing 110 can include a plurality of additive injectors 130. As discussed in greater detail elsewhere herein, the additive injectors 130 can be manufactured and configured specifically for reducing (or eliminating) any dripping and/or cross contamination of additive fluids (e.g., flavors, vitamins, minerals, compounds, syrups, concentrates, liquids). Each of the additive injectors 130 can be configured to securely connect to a respective flavor hose, tubing, or the like. The additive injectors 130 can be barbed (e.g., externally barbed, such as in the same or similar fashion as the illustrated first inlet 112) for securely connecting to one or more corresponding additive sources 154 via one or more tubes or hoses. The additive injectors 130 can be configured to inject or otherwise introduce liquid additives (e.g., flavoring) towards a flow stabilizer 140 (e.g., at or near the lowermost portion of the nozzle assembly 100, at or near the dispensing outlet 113 of the nozzle assembly 100). For example, fluid received by the nozzle assembly 100 (e.g., through the first inlet 112 and/or the second inlet 213) can eventually exit (e.g., be discharged and/or dispensed) through the dispensing outlet 113 (e.g., at or near the bottom of the nozzle assembly 100). The location, angle, volume, and flow speed by which additive(s) are injected by the additive injector(s) 130 into fluid passing thereby can help facilitate mixing of the additive(s) into the passing fluid. For example, the additive(s) can flow with the fluid across at least a portion of the flow stabilizer 140 as the mixture exits the dispensing outlet 113.

The nozzle assembly 100 (e.g., the nozzle housing 110) can include one or more tabs 114. For example, the nozzle housing 110 can include tabs 114, which can interface with and/or connect to corresponding slots, holes, depressions, grooves, receptacles, or the like within a beverage dispensing device (or housing thereof) for securely positioning the nozzle assembly 100 within the housing of the beverage dispensing device. Thus, the tab(s) 114 can generally secure a position and orientation of the nozzle assembly 100 within a beverage dispensing machine (e.g., beverage dispensing device 1600, as discussed more fully elsewhere herein).

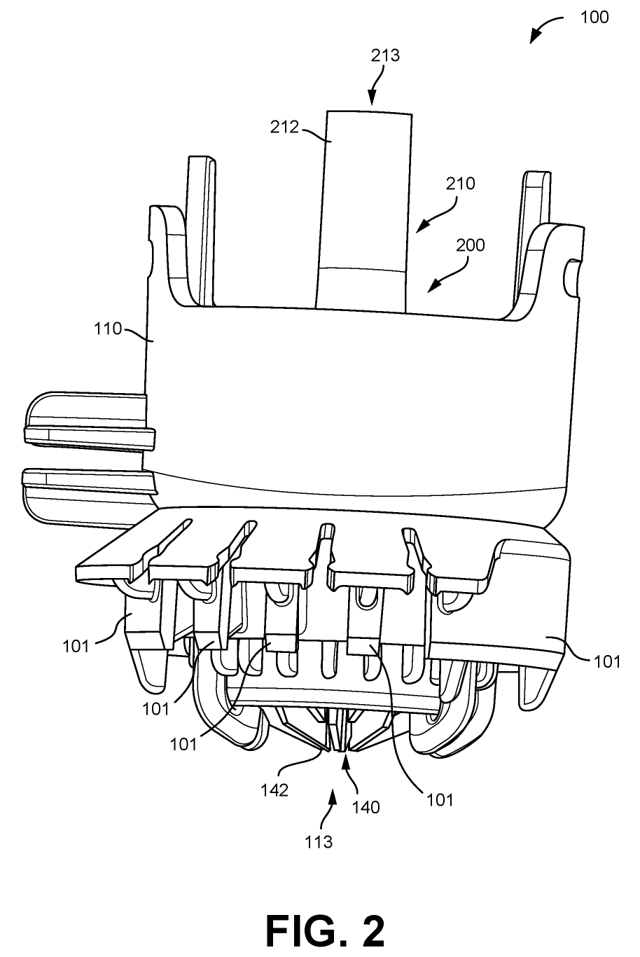

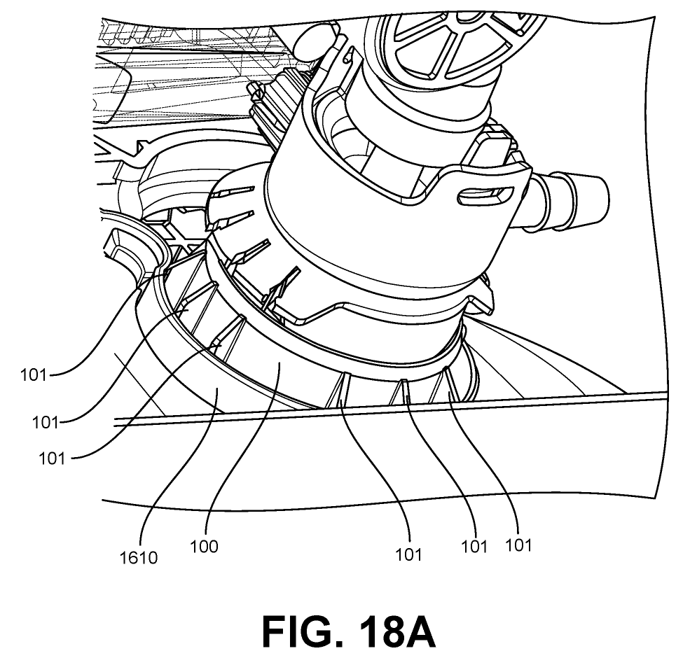

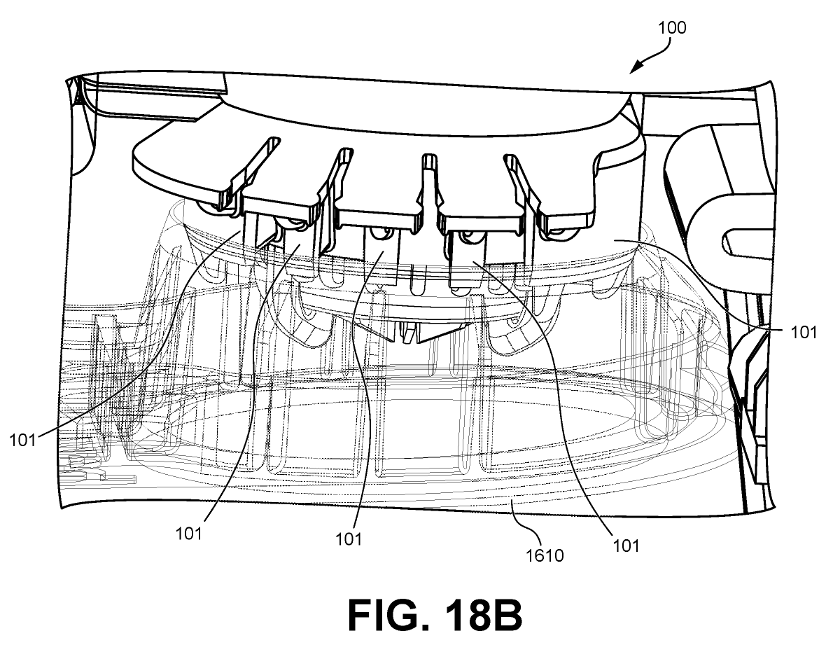

Alternatively or in addition, and referring now to FIG. 2, the nozzle assembly 100 can include one or more alignment fins 101. The alignment fins 101 can extend at least partially in the vertical direction (e.g., the general direction of fluid flowing out of the nozzle assembly 100, such as the direction by which fluid flows from the dispensing outlet 113). The alignment fins 101 can be a part of the unitary structure of the nozzle housing 110, as a non-limiting example. The alignment fins 101 can extend and/or protrude from an exterior surface of the nozzle housing 110, and the alignment fins 101 can be configured to abut or otherwise interface with the housing and/or any other component(s) of the beverage dispensing device (e.g., one or more internal surfaces of the boot 1610, as discussed in more detail elsewhere herein). As shown in FIG. 2 (and also in FIG. 18B), the alignment fins 101 can have any width (or arc length), and the alignment fins 101 can be configured to maintain the nozzle assembly 100 in a desired position with respect to one or more components of the beverage dispensing device the opening of the boot 1610 (e.g., centered and/or having a shared central axis). As a non-limiting example, at least some of the alignment fins 101 can be configured to flex inwardly when the nozzle assembly 100 (e.g., the nozzle housing 110) is inserted into the opening (e.g., inner perimeter) of the boot 1610; such alignment fins 101 can thus push outwardly against the boot 1610, thereby maintaining alignment and/or positioning of the nozzle assembly 100 to the boot 1610 via friction forces.

Referring back to FIG. 1, the nozzle assembly 100 can be operatively connected to a controller 150. The controller 150 can be or include a computing system, which can include one or more processors and memory having instructions stored thereon that, when executed by the one or more processors, can cause the controller to perform one or more methods, processes (e.g., process 1900 discussed more fully herein), steps, actions, or the like. As a non-limiting example, the controller 150 can be in operative communication with, and configured to control, one or more pumps, one or more valves, one or more actuators, one or more carbonation tanks, one or more carbonating devices or systems, or the like, or any combination thereof to cause one or more fluids and/or one or more additives to flow to the nozzle assembly 100. It is to be understood that, as a non-limiting example, any given fluid source 152 and/or any given additive source 154 can include the one or more pumps, the one or more valves, the one or more actuators, the one or more carbonation tanks, the one or more carbonating devices or systems, or the like, or any combination thereof. Alternatively or in addition, the controller 150 can be in communication with one or more sensors of the beverage dispensing device (e.g., liquid sensor, hygrometer, capacitive sensor), and the controller 150 can be configured to make various determinations, adjustments, or the like based at least in part on sensor data received from the sensor(s). Alternatively or in addition, the controller can be configured to output instructions for one or more components (e.g., one or more pumps, one or more valves, one or more actuators) based at least in part on sensor data received from the sensor(s).

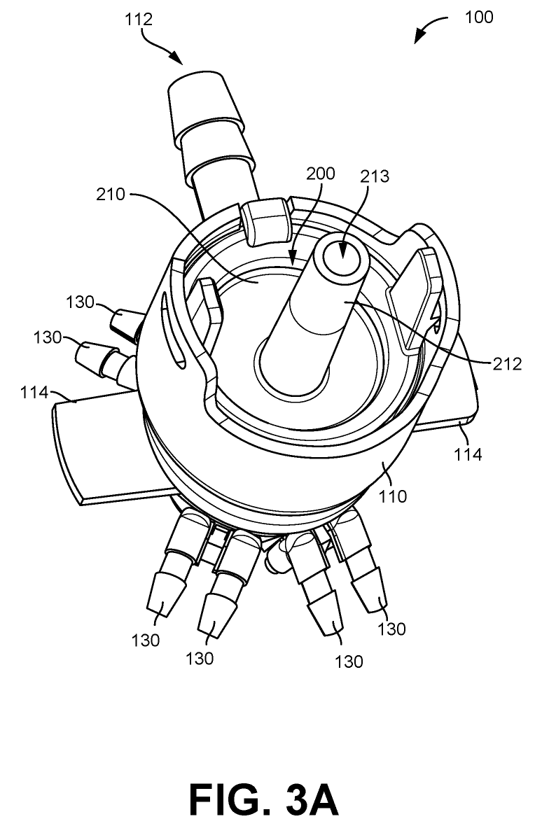

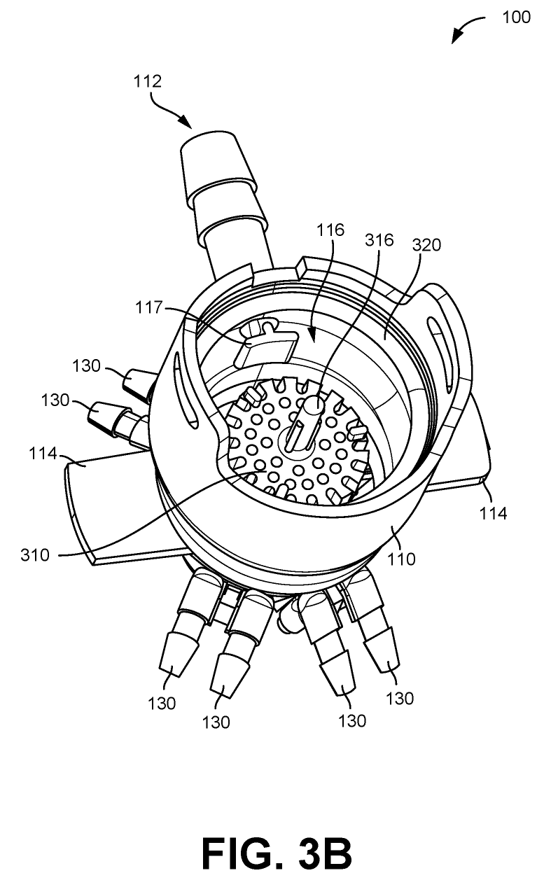

FIGS. 3A and 3B illustrate a top view of the nozzle assembly 100, with FIG. 3A showing the nozzle assembly 100 with the screen housing 210 and FIG. 3B showing the nozzle assembly 100 without the screen housing 210. The nozzle assembly 100 can include a screen assembly 200, which can include a screen housing 210 and one or more screens (e.g., a first screen 310 and/or a second screen 410, as discussed more fully herein). The screen housing 210 can include a hollow portion that can at least partially receive one or more screens.

The nozzle assembly 100 can include an inlet stem 212, which can extend in a generally upward direction from a screen housing 210. The screen housing 210 can be detachably attachable to the nozzle housing 110. Accordingly, the screen housing 210 can be removed to expose (and access) various nozzle components within an interior of the nozzle housing 110 (e.g., as shown by FIG. 3B). As a non-limiting example, the inlet stem 212 and the screen housing 210 can be a unitary component. Alternatively or in addition, the screen housing 210 can be detachably attachable to the nozzle housing 110 via one or more latches, screws/threads, spring mechanisms, or the like (e.g., via one or more deformable and/or bendable arms—each having a protrusion—on one of the screen housing 210 or the nozzle housing 110 and one or more corresponding mating recesses on the other of the nozzle housing 110 or the screen housing 210). Regardless, the screen housing 210 can create a seal between the screen housing 210 and the nozzle housing 110 (e.g., via a gasket 320) such that fluid (e.g., water, air) and/or pressure cannot exit the nozzle assembly 100 through or adjacent to the screen housing 210. Various features of the screen housing 210 can promote a downward flow of fluid through the nozzle assembly 100.

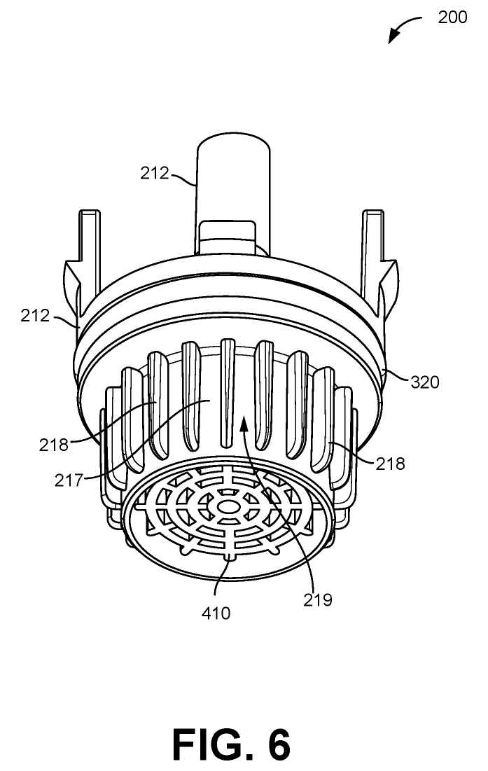

As will be shown and discussed in connection with FIG. 6, for example, the screen housing 210 can include an outer wall 217, and at least a portion of the outer wall 217 can be generally ribbed. For example, the outer wall 217 can include a plurality of ribs 218 that at least partially define a plurality of channels 219 through which fluid can flow. Alternatively or in addition, a given channel 219 can be defined at least in part by one or more channels 219, a portion of the outer wall 217, and a portion of one or more inner surfaces of the nozzle housing 110. The channels 219 can extend downward into an interior of the nozzle housing 110. As previously explained, the screen housing 210 can include a hollow portion (e.g., a dispersion chamber 216) that can at least partially receive one or more screens, which can suppress and/or decrease the velocity of fluid (e.g., fluid received at the second inlet 213) to promote a gentle stream of fluid (e.g., exhibiting laminar flow) while exiting the nozzle assembly 100 (e.g., at the dispensing outlet 113).

The inlet stem 212 can have a generally cylindrical shape, and the inlet stem 212 can include and/or at least partially define the second inlet 213. For example, the inlet stem 212 can comprise a hollow portion (e.g., generally cylindrical, generally conically shaped, at least a portion thereof being tapered), and the second inlet 213 can be or include the hollowed volume within the inlet stem 212 through which fluid can be received. Alternatively or in addition, an upper end of the inlet stem 212 can be securely connected to a fitting 120, which can further be connected (at an opposite end) to tubing fluidly connected a fluid source 152.

As shown in FIG. 3B, components of the nozzle assembly 100 can include (but are not limited to) one or more screens—which can include the illustrated first screen 310—and a flow diverter 117 (e.g., which can be attached to, or integral with, the nozzle housing 110) and a first screen 310.

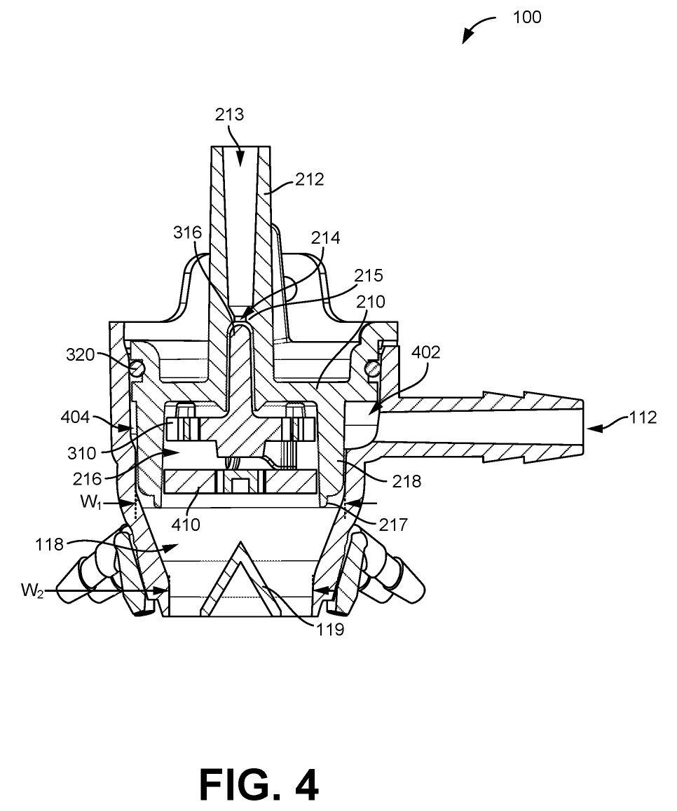

The first screen 310 can include a body 312, one or more (e.g., a plurality) apertures 314 extending through the body 312, and/or a mating protrusion 316. The mating protrusion 316 can be configured to extend at least partially within, and/or mate with, a corresponding space or slot within screen housing 210 (e.g., within a lower portion of the inlet stem 212). The mating protrusion 316 can include a rounded or spherical upper tip. Fluid flowing through the second inlet 213 and/or within the inlet stem 212 can be interrupted (or restricted) by the mating protrusion 316. As will be discussed in greater detail below in connection with FIG. 4, the spherical upper tip of the mating protrusion 316 can promote an equal or substantially equal dispersion or diversion of a fluid stream around the surface area of the mating protrusion 316. In response to the mating protrusion 316 diverting the fluid stream to flow around the mating protrusion 316, the fluid can flow along at least some of the length of the mating protrusion 316 and can encounter the first screen 310. The first screen 310 can be one of at least two or more screens that are configured to suppress, quell, subdue, lessen or generally decrease the velocity of fluid flowing through the nozzle assembly 100. The apertures 314 of the first screen 310 (and/or other screens discussed herein) can include any combination of holes, slits, vents, apertures, or any other feature through which fluid can flow, each having any size or shape. The various apertures 314 can each have the same size or shape, or at least one aperture can have a size and/or shape that is different from the size and/or shape of at least one other aperture. The size and/or shape of a given aperture 314 can be constant along the length of the aperture 314 (e.g., along the thickness of the body 312), or the size and/or shape of a given aperture 314 can change (e.g., taper) along the length of the aperture 314 and/or along the thickness of the body 312.

As will be discussed in greater detail below, the two or more screens can be configured and/or arranged such that the aperture patterns of any two consecutively stacked (adjacent) screens are purposefully misaligned. Stated differently, one, some, or all apertures 314 of the first screen 310 can be misaligned (e.g., at least partially offset, entirely offset, in the vertical direction) with one, some, or all of the apertures of a subsequent screen (e.g., apertures 414 of the second screen 410). Accordingly, fluid that flows downwardly through apertures in the first screen 310 generally cannot continue to flow through holes in a second screen (e.g., apertures 414 of the second screen 410) without dispersing laterally. The nozzle assembly 100 can include two or more screens within the interior portion 116 of the nozzle housing 110 (and/or within the dispersion chamber 216 of the screen housing 210), which can be configured to control (e.g., decrease) the velocity of fluid flowing (e.g., flowing downwardly) through the interior portion 116, such as by promoting flow dispersion and thus quelling the flow velocity. Alternatively or in addition, the two or more screens within the interior portion 116 can be configured to control a width of the flow path of the fluid flowing through the interior portion 116 (e.g., by promoting flow dispersion across the width of the two or more screens).

The nozzle housing 110 can include the flow diverter 117, as a non-limiting example. Regardless, the flow diverter 117 can be positioned at, near, or otherwise in close physical proximity to a mouth, opening, or end where fluid flowing through the first inlet 112 can enter the interior portion 116. The flow diverter 117 can be positioned generally perpendicularly to the flow of fluid entering the interior portion 116 from the first inlet 112. The flow diverter 117 can include a face and/or a nose. The nose can extend outwardly from the face and toward the mouth of the first inlet 112. The nose can include a pointed, chamfered, and/or rounded edge for diverting fluid flow in generally equal directions away from the nose. For example, the inner wall of the nozzle housing 110 can include a convex curvature relative to the first inlet 112 (e.g., concave as viewed from within the interior portion 116). The convex curvature can promote the flow of fluid around a cavity (e.g., an eccentric cavity) disposed between the interior surface of the nozzle housing 110 and the outer wall 217 of the screen housing 210.

FIG. 4 is a cross-sectional view of the nozzle assembly 100. As shown, the eccentric cavity can include an eccentric cavity front portion 402 and an eccentric cavity rear portion 404. The eccentric cavity can be a generally annular cavity within the interior portion 116 (e.g., between the interior surface of the nozzle housing 110 and the outer wall 217 of the screen housing 210). The eccentric cavity is eccentric (and not concentric) because the center points corresponding to the cavity outer perimeter and cavity inner perimeter are not aligned (e.g., not concentric). In the example illustrated in FIG. 4, the center point corresponding to the cavity inner perimeter is shifted away from the first inlet 112. Accordingly, the eccentric cavity front portion 402 can have a larger width (and thus larger cross-sectional area and volume) than the width at the eccentric cavity rear portion 404. Therefore, as fluid is received at the eccentric cavity front portion 402 (e.g., from the first inlet 112), the fluid can fill the cavity as it is directed (e.g., via the walls of the cavity and/or the outer wall 217 of the screen housing 210) towards the eccentric cavity rear portion 404. A gradual decrease or taper in cavity width from the eccentric cavity front portion 402 towards the eccentric cavity rear portion 404 can direct the fluid flow into one or more ribs 218 (e.g., ribs 218 extending at least partially in a generally vertical direction, ribs 218 extending in the general vertical direction) protruding outwardly from the outer wall 217 of the screen housing 210. For example, as fluid fills the cavity from the eccentric cavity front portion 402 towards the eccentric cavity rear portion 404, the direction of fluid flow is generally perpendicular to the ribs 218, and the at least partially perpendicular orientation of the ribs 218 relative to the fluid flow can result in the ribs 218 disrupting (or catching) the fluid flowing closest to the ribs 218. The gradual decrease in cavity width can reduce the volume in which the fluid can avoid contacting the plurality of ribs 218. Accordingly, the fluid stream received from the first inlet 112 can be gradually directed into the ribs 218. The ribs 218 (e.g., gaps or spaces between adjacent ribs 218) can create or at least partially define chutes and/or channels 219, through which fluid can flow through the interior portion 116. The gradual decrease in eccentric cavity width and/or the arrangement of ribs 218 and corresponding channels 219 can result in fluid filling the eccentric chamber and being caught, or disturbed, by the ribs 218, which can suppress and/or decrease the velocity of the fluid flow received from the first inlet 112 and can furthermore promote a gentle and controlled flow of the fluid though the interior portion 116 and into an exit chamber 118 of the nozzle housing 110.

The exit chamber 118 can be located at a lower portion of the nozzle assembly 100 (e.g., a lower portion of the nozzle housing 110) within which fluid flowing from first inlet 112 and/or the second inlet 213 can be manipulated (e.g., further manipulated) prior to exiting at the dispensing outlet 113. The width between interior sidewalls of the nozzle housing 110 can taper below the ribs 218 and the outer wall 217 to form and/or at least partially define the exit chamber 118. For example, as shown in FIG. 4, an upper portion of the exit chamber 118 (e.g., immediately below screen assembly 200) can have a first width and/or diameter W₁, a lower portion of the portion of the exit chamber 118 (e.g., immediately above the dispensing outlet 113) can have a second width and/or diameter W₂. The second width and/or diameter W₂ can be less than or equal to the first width and/or diameter W₁. For example, the width and/or diameter of the exit chamber 118 can decrease (e.g., gradually decrease, taper) from the first width and/or diameter W₁ to the second width and/or diameter W₂. Alternatively or in addition, the taper of the width and/or diameter of exit chamber 118 can promote an even or approximately even spread or dispersion of fluid flowing through the exit chamber 118.

Continuing with the discussion of FIG. 4, the inlet stem 212 can include an inlet channel extending from the second inlet 213 and along at least a portion of the length of the inlet stem 212. As illustrated, the inlet channel can taper from a first diameter at or near the second inlet 213 to a second, smaller diameter. For example, the inlet stem 212 can include an annular protrusion 215 extending radially inward into the inlet channel. Alternatively or in addition, the annular protrusion 215 can have a generally concave (e.g., from the perspective of the second inlet 213) and/or rounded surface. As a non-limiting example, the annular protrusion 215 can generally separate the inlet channel from a mating cavity 214, which can be or include a generally hollow space within inlet stem 212 (e.g., in fluid communication with the second inlet 213) that can be configured to at least partially receive the mating protrusion 316 to thereby position or secure the screens (e.g., the first screen 310) with respect to the screen housing 210). For example, when the mating protrusion 316 is positioned at least partially within the mating cavity 214, the mating protrusion 316 outer surface(s) of the mating protrusion 316 can be distanced apart from the inner surface(s) of the mating cavity 214, such that the mating protrusion 316 does not physically contact any surfaces within the mating cavity 214. Accordingly, the mating cavity 214 and the mating protrusion 316 can combine to define a narrow channel (e.g., having an annular cross-sectional shape) through which fluid, as received from the second inlet 213, can flow. Stated differently, fluid received from the second inlet 213 can be dispersed about and/or around the surface area of the mating protrusion 316 while flowing through the mating cavity 214. In at least one example, fluid exiting the bottom of the mating cavity 214 can enter a dispersion chamber 216.

The dispersion chamber 216 can include a volume defined at least in part by an upper surface of the screen housing 210 and the outer wall 217. The screen housing 210 (e.g., the dispersion chamber 216) can have a generally open bottom end. The dispersion chamber 216 can include and/or at least partially encompass two or more stacked screens. For example, the dispersion chamber 216 shown in FIG. 4 includes the first screen 310 and a second screen 410. For example, fluid exiting the bottom of the mating cavity 214 can enter the dispersion chamber 216 and fall and/or flow through one or more apertures 314 of the first screen 310. Accordingly, the velocity of fluid exiting the bottom of the mating cavity 214 can be lessened by the first screen 310 at least because the holes (e.g., apertures 314) generally impede the fluid flow. The fluid flowing through the holes in the first screen 310 can fall onto the second screen 410. The second screen 410 can include a body 412 and one or more (e.g., a plurality) apertures 414 extending through the body 312a plurality of holes arranged in a pattern that is at least partially offset and/or misaligned with respect to the apertures 314 of the first screen 310. Accordingly, the fluid flowing through the apertures of the first screen 310 can again be impeded by second screen 410, and causing the fluid flow to be dispersed across the upper surface of the second screen 410 until falling and/or flowing through the apertures 414 of the second screen 410.

Alternatively or in addition, the fluid falling through the apertures 414 of the second screen 410 can subsequently fall onto a flow spreader 119. The flow spreader 119 can be attached to, or integral with, the nozzle housing 110. Alternatively or in addition, the flow spreader 119 can be generally cone-shaped and/or can be positioned below the second screen 410. The flow spreader 119 and the second screen 410 can share a common central vertical axis. Alternatively or in addition, the flow spreader 119 can be oriented such that the cone apex is closer to the second screen 410 than any other portion of the flow spreader 119. As a non-limiting example, fluid falling through the aperture 414 of the second screen 410 can fall onto the flow spreader 119, and the flow spreader 119 can direct the fluid to fall along its surface, thus widening and/or increase the diameter of the fluid flow. By widening the flow diameter, the flow spreader 119 can create a wider target for additive injection. The widening of the flow diameter can primarily occur at an uppermost portion of the flow spreader 119, as a non-limiting example. Alternatively or in addition, the widening of the flow diameter can prevent the dispensed stream of fluid from sticking to one side of the nozzle assembly 100 (e.g., one side of the dispensing outlet 113). By directing the fluid to fall and/or flow along its conical surface, the flow spreader 119 can promote a wetting of the entirety of the flow spreader 119 outer surface area and/or a wetting of the interior sidewall of the nozzle housing 110, which can help provide a visually consistent stream of fluid exiting the dispensing outlet 113.

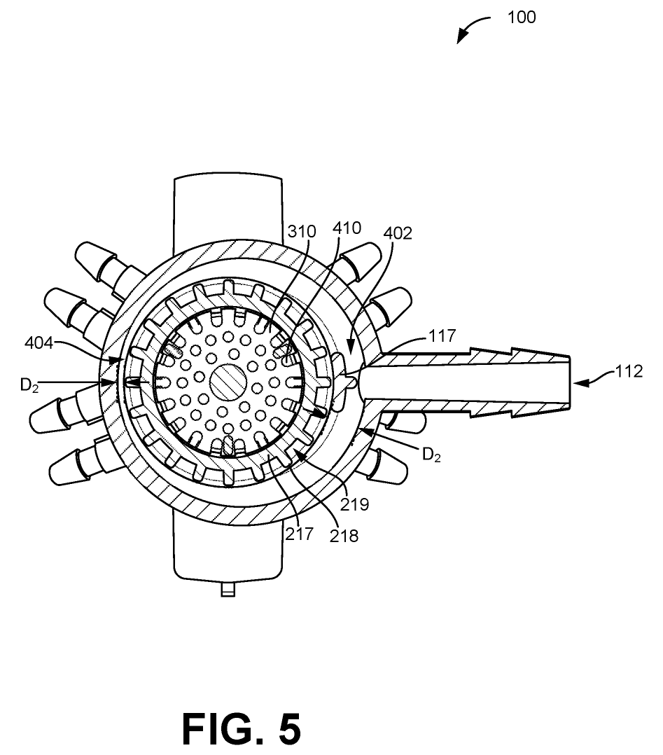

FIG. 5 is a cross-sectional view of the nozzle assembly 100, illustrating the eccentric chamber and first screen 310 in particular. As shown, the eccentric cavity front portion 402 can have a first width and the eccentric cavity rear portion 404 can have a second width. The first width of the eccentric cavity front portion 402 can be greater than the second width of the eccentric cavity rear portion 404, thereby causing the eccentric cavity front portion 402 to have a larger cross-sectional area and corresponding volume than the eccentric cavity rear portion 404. The width of the eccentric cavity can taper (e.g., gradually taper, taper at a constant or near-constant rate of change) between the first width and the second width. Stated differently, one or more eccentric cavity intermediate portions, which can be located between the eccentric cavity front portion 402 and the eccentric cavity rear portion 404, can each have a corresponding width that is greater than or equal to the second width and less than or equal to the first width. Accordingly, the outermost surface of the screen housing 210, the first screen 310, and/or the second screen 320 can be positioned within the interior portion 116 of the nozzle housing 110 such that a first distance D₁ exists between the inner surface of the nozzle housing 110 at the eccentric cavity front portion 402 and the corresponding outer surface of the screen housing 210, the first screen 310, and/or the second screen 320, and a second distance D₂ exists between the inner surface of the nozzle housing 110 at the eccentric cavity rear portion 404 and the corresponding outermost surface of the screen housing 210, the first screen 310, and/or the second screen 320.

In any event, the nozzle housing 110 can have one or more features, shapes, dimensions, or the like configured to cause any fluid is received at the eccentric cavity front portion 402 (e.g., from the first inlet 112) to be split into two or more flow paths (e.g., by the flow diverter 117) to thereby flow through the eccentric cavity toward the eccentric cavity rear portion 404. Any gradual decrease or taper in cavity width from the eccentric cavity front portion 402 towards the eccentric cavity rear portion 404 can help direct fluid flow against the outer wall 217 of the screen housing 210, which can include the ribs 218 protruding outwardly therefrom to thereby define a plurality of channels the outer wall 217. The ribs 218 can extend radially outward from the outer wall 217, and one, some, or all of the ribs 218 can have a longitudinal axis extending at least partially in the general vertical direction. For example, the ribs 218 can extend in the generally vertical direction such that the generally vertical ribs 218 at least partially define generally vertical channels 219. Alternatively or in addition, one, some, or all of the ribs 218 can have a length that extends at least partially in the vertical direction and at least partially in a circumferential direction. For example, one or more of the ribs 218 can have a generally helical or screw-like configuration, which can cause one or more corresponding channels 219 to have a generally helical or screw-like configuration

In any event, and as previously explained, as fluid fills the cavity from the eccentric cavity front portion 402towards the eccentric cavity rear portion 404, the direction of fluid flow can be generally perpendicular to the ribs 218 protruding from the outer wall 217, and the perpendicular orientation of the ribs 218 relative to the fluid flow can result in the ribs 218 disrupting (or catching) the fluid flowing closest to the ribs 218. The gradual decrease in cavity width can reduce the volume in which the fluid can freely flow (e.g., the volume in which the fluid can avoid contacting the ribs 218). Accordingly, the fluid stream received from the first inlet 112 can be gradually directed at and/or into contact with the ribs 218. As such, the ribs 218 can suppress, or generally slow, the velocity of the fluid received from the first inlet 112 and can furthermore promote a gentle and controlled fall of the fluid though the channel 219 and into the exit chamber 118 of the interior portion 116.

Also shown in FIG. 5 is the first screen 310. The first screen 310, and the one or more screens stacked below the first screen 310 (e.g., the second screen 410) can be positioned at least within and/or encompassed at least partially by the interior surface of the outer wall 217. The screens (e.g., the first screen 310, the second screen 410) can be arranged such that hole patterns (e.g., apertures 314, 414) of any two consecutively stacked (adjacent) screens are purposefully misaligned (e.g., partially or fully offset in the generally vertical direction). Accordingly, fluid that flows downwardly through apertures 314 in the first screen 310 can be generally prevented from continuing to flow through apertures 414 in a second screen 410 without first dispersing laterally across an upper surface of the second screen 410. The first screen 310 and the second screen 410 can be configured to control the velocity of fluid received from the second inlet 213 (e.g., by promoting flow dispersion, and thus subduing the flow velocity). Alternatively or in addition, the two or more screens located within the dispersion chamber 216 can be configured to control the width of the flow path of the fluid as it flows downwardly through the dispersion chamber 216 and/or interior portion 116, such as by promoting flow dispersion across the width(s) of the two or more screens.

FIG. 6 illustrates a bottom view of the screen assembly 200, showing the screen housing 210 and the second screen 410 in particular. As shown, the second screen 410 can be disposed at least partially within (e.g., at least partially encompassed by) the outer wall 217 of the screen housing 210. As discussed elsewhere herein, the screen housing 210 can include ribs 218 protruding radially outward from the outer wall 217, and the open spaces between pairs of adjacent ribs 218 can each corresponding to a channels 219 through which fluid (e.g., fluid received from the first inlet 112) can flow.

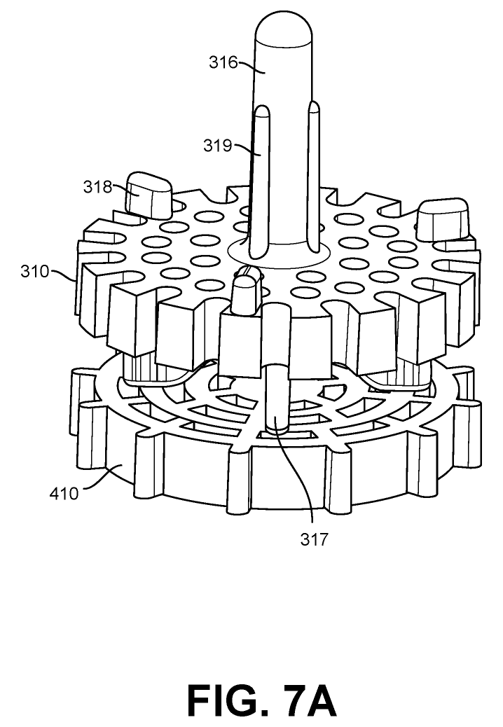

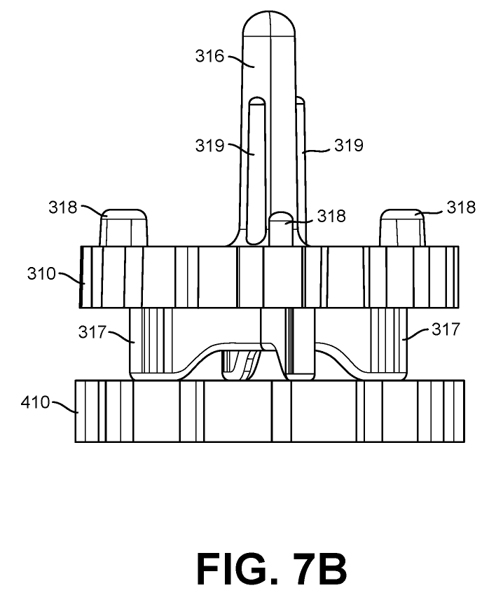

FIGS. 7A and 7B illustrate different views of an example pair of stacked screens, which can include the first screen 310 and the second screen 410, as a non-limiting example. As shown, the first screen 310 can include one or more legs 317 protruding from a bottom surface of the body 312 of the first screen 310. As a non-limiting example, the leg(s) 317 can abut and/or rest on an upper surface of the second screen 410. Accordingly, the leg(s) 317 can function as spacers between the first screen 310 and the second screen 410 (e.g., to ensure the appropriate volume exists between the screens for fluid dispersion as fluid flows therebetween). Alternatively or in addition, the first screen 310 can include one or more spacers 318 protruding from the upper surface of the first screen 310. Alternatively or in addition, the spacers 318 can provide a space between the first screen 310 (e.g., the top surface of the body 312) and the interior surface(s) of the screen housing 210 (see, e.g., FIG. 4) to enable adequate fluid dispersion within that space as fluid flows down (and around) the mating protrusion 316 and onto the first screen 310. Alternatively or in addition, the second screen 410 can include one or more legs (e.g., the same as, or similar to, the leg(s) 317) that protrude from the top of the body 412 of the second screen 410, such that the upwardly extending legs of the second screen 410 abut a lower surface of the first screen 310.

As illustrated, the first screen 310 can include apertures 314 having a hole pattern that is different than the hole pattern of the apertures 414 of the second screen 410. For example, the hole pattern of the first screen 310 can include generally circular apertures 314 within an inner portion of the body 312 and/or can include generally semi-oblong-shaped apertures 314 at or near an outer perimeter of the body 312. Alternatively or in addition, the apertures 314 can be arranged concentrically around a center of the first screen 310. Alternatively or in addition, the hole pattern of the second screen 410 can include apertures 414 within an inner portion of the body 412 that have a generally rectangular shape and/or a generally curved rectangular shape (e.g., an arched rectangle). Alternatively or in addition, the apertures 414 can be arranged concentrically around the center of the body 412 of the second screen 410. Alternatively or in addition, the second screen 410 can include ribs (e.g., rounded vertical tabs) extending radially outwardly from an outer sidewall of the body 412. As can be seen in FIG. 5, for example, the first screen 310 and the second screen 410, when arranged in the stacked configuration, can have partially or fully offset hole patterns. Stated differently, when viewed from directly above the stacked screen (e.g., as shown in FIG. 5), the body 312 of the first screen 310 can obscure visibility of some or all of the apertures 414 of the second screen (e.g., the hole pattern of the second screen 410 cannot be seen through the hole pattern of the first screen 310) because the hole patterns are purposefully misaligned to prevent fluid from flowing through apertures 314, 414 of both screens along a direct, vertical flow path, which can effect a reduction in flow velocity as the fluid flows through the nozzle assembly 100.

Alternatively or in addition, the first screen 310 can include one or more protrusion spacers 319. For example, the protrusion spacer(s) 319 can protrude outwardly (e.g., radially outward) from the mating protrusion 316. The mating protrusion 316 can include any number of protrusion spacers 319 (e.g., 2, 3, 4, 5, etc.). Alternatively or in addition, the protrusion spacers 319 can be spaced equidistantly from each other around the circumference of the mating protrusion 316. A given protrusion spacer 319 can abut a corresponding surface of the sidewall of the mating cavity 214. Alternatively or in addition, a given protrusion spacer 319 can extend at least partially into and/or mate with a corresponding space (e.g., depression) at, on, or within the sidewall of the mating cavity 214. In any event, the protrusion spacer 319 can prevent the first screen 310 from shifting or spinning while fluid is flowing through mating cavity 214 and/or the first screen 310. Alternatively or in addition, the protrusion spacer 319 can provide a particular space, gap, or channel (e.g., of a constant width about the perimeter of the mating protrusion 316) between the exterior surface of the mating protrusion 316 and the mating cavity 214.

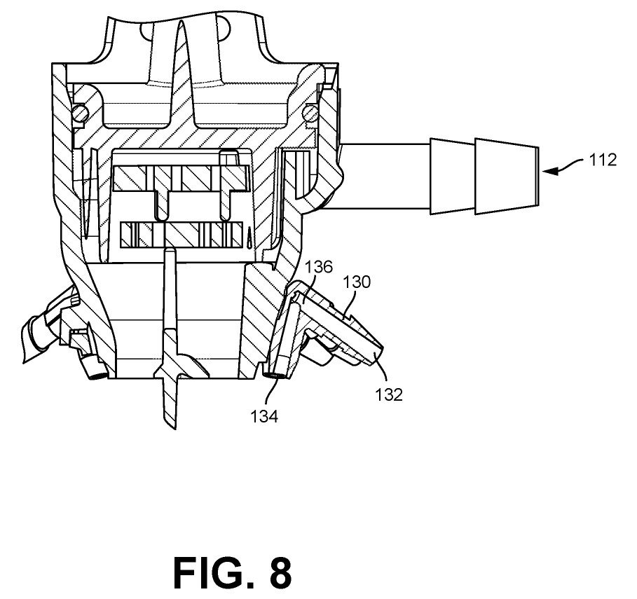

FIG. 8 illustrates a cross-sectional view of the nozzle assembly 100, including an additive injector 130. The additive injectors 130 can be separate components attached to the nozzle housing 110, or the additive injectors 130 can be integral with the nozzle housing 110. As a non-limiting example, a given additive injector 130 can have a generally bent shape. Stated differently, a given additive injector 130 can be generally elbow shaped (e.g., having a bend, having an angle of less than 180°, having an acute angle, having an obtuse angle, having an approximately right angle). The elbow shape of the additive injector 130 can reduce dripping and/or cross contamination of various additives (e.g., flavors). A given additive injector 130 can be manufactured from and/or comprise a low surface energy (LSE) material. As will be understood by one of ordinary skill in the art, LSE materials generally resist bonding given LSE materials have a weak attraction for adhesives and other liquids. In general, materials with a surface energy below 36 dynes/cm are typically considered low surface energy materials. As a more specific example, a given additive injector 130 can be manufactured from and/or comprise silicon, which can have an LSE in the range from about 24 dynes/cm to about 35 dynes/cm. Alternatively or in addition, a given additive injector 130 can be manufactured from polyvinyl chloride (PVC), which can have an LSE in the range from about 35 dynes/cm to about 39 dynes/cm. In general, the additive injector can be manufactured from and/or comprise any material having a surface energy in the range from about 19 dynes/cm to about 36 dynes/cm. Notwithstanding the LSE materials mentioned above, it should be understood from the discussion herein that the additive injectors 130 (or any other component of the nozzle assembly 100) can be manufactured from and/or comprise any material with an appropriate surface energy.

The generally bent additive injector’s 130 elbow shape can enable the additive injector 130 to maintain an overall compact form factor. The elbow angle at the injector apex 136 (e.g., the angle of the bend of the additive injector 130) can be an acute angle. As a non-limiting example, the elbow angle can be in the range from about 20 degrees to about 90 degrees. Alternatively or in addition, the additive injector 130 can have an injector inlet 132 and an injector outlet 134. The injector inlet 132 can be operatively connected to one or more additive sources 154, which can include a corresponding pump (e.g., a peristaltic pump) and tubing. The pump can be operatively configured to push an additive (e.g., a liquid) through the tubing, into the injector inlet 132, through a bent flow path (e.g., internal channel) of the additive injector 130, and out of the injector outlet 134. The injector outlet 134 can direct the additive toward a fluid stream flowing at or from the dispensing outlet 113 (e.g., in an at least partially downward direction). The additive can, at least in part, be pulled downward through the injector outlet 134 via gravity. Alternatively or in addition, any LSE material (or other appropriate material) included by the additive injector 130 can reduce, or eliminate, residual additives (e.g., residual flavoring) within the injector outlet 134 and/or within the interior channel of the additive elbow 130). Reducing residual additives (e.g., residual flavoring) within the additive injector 130 or a portion thereof (e.g., the injector outlet 134, at least a portion of the interior channel) can reduce or eliminate dripping and/or cross contamination between or among additives or other fluids. As a more specific example, the LSE material can reduce residual additive build-up at least by promoting minimal film formation (e.g., from the additive(s)) as the corresponding pump is reversed and pulls any additive still within the additive injector 130 away from the injector outlet 134 and past the injector apex 136 (e.g., on the inlet side of the injector apex 136). Reversing the pump can include a control sequence including ramping down, stopping, and/or ramping up a pump in a reverse direction. The pump reversal control sequence (e.g., ramping down) can gradually stop additive injection (e.g., during the dispensing process) to eliminate or mitigate additive dribbling and/or splattering. For example, the control sequence can promote a gentle retraction of flavoring behind (e.g., on the inlet side) the injector apex 136, which can cause any additive remaining within the channel of the additive injector to be held within the interior channel on the inlet side of the injector apex 136. In contrast, an abrupt pump reversal can pull mostly air (and little or no additive) past the injector apex 136. In response to pulling the additive past the injector apex 136, the additive generally cannot escape the additive injector 130 through the injector outlet 134 unless the pump is reactivated to push additive over the injector apex 136 and to the outlet size of the interior channel.

The length of the outlet side of the additive injector (e.g., the portion of the interior channel extending from the injector outlet 134 to the injector apex 136) can be a particular length that causes any residual liquid additive to form a film along the outlet side, instead of dripping out from the injector outlet 134. While including an LSE material in the additive injector 130 can prevent film from forming along a length of the injector outlet 134, the injector outlet 134 length have a sufficiently long length to prevent any residual liquid additive from dripping from the injector outlet 134, even upon coalescing (e.g., due to the nominal residual flavoring forming a film before coalescing into a volume capable of dripping). In response to receiving a signal to stop additive injection, the additive pump can be operatively configured to reverse the flow of the additive such that the additive is pulled away from the injector apex 136 of the additive injector 130 (and/or the additive pump can so act in response to receiving corresponding instructions from the controller 150). Pulling the additive past and generally away from the injector apex 136 of the additive injector 130 can ensure that no additional additive escapes through the injector outlet 134 (e.g., via gravity and/or low fluid surface tension).

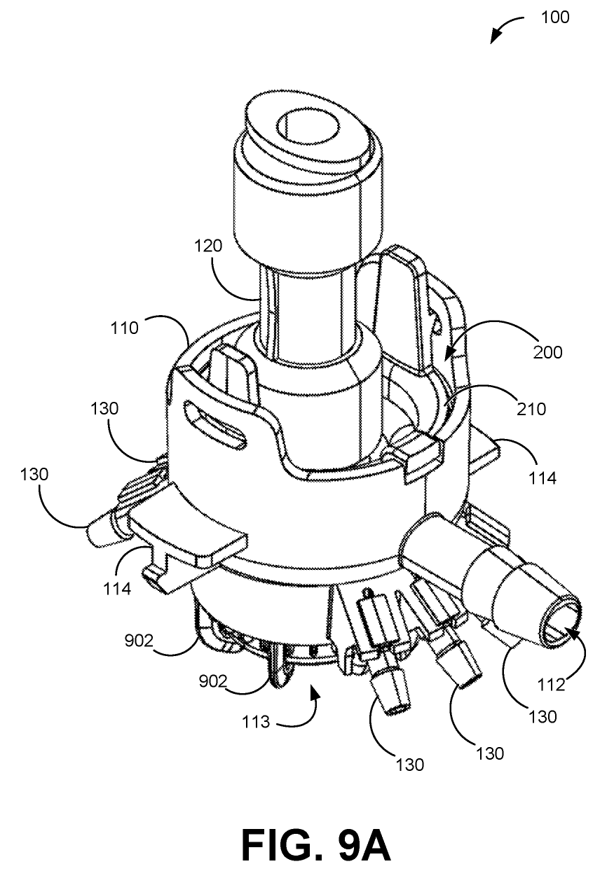

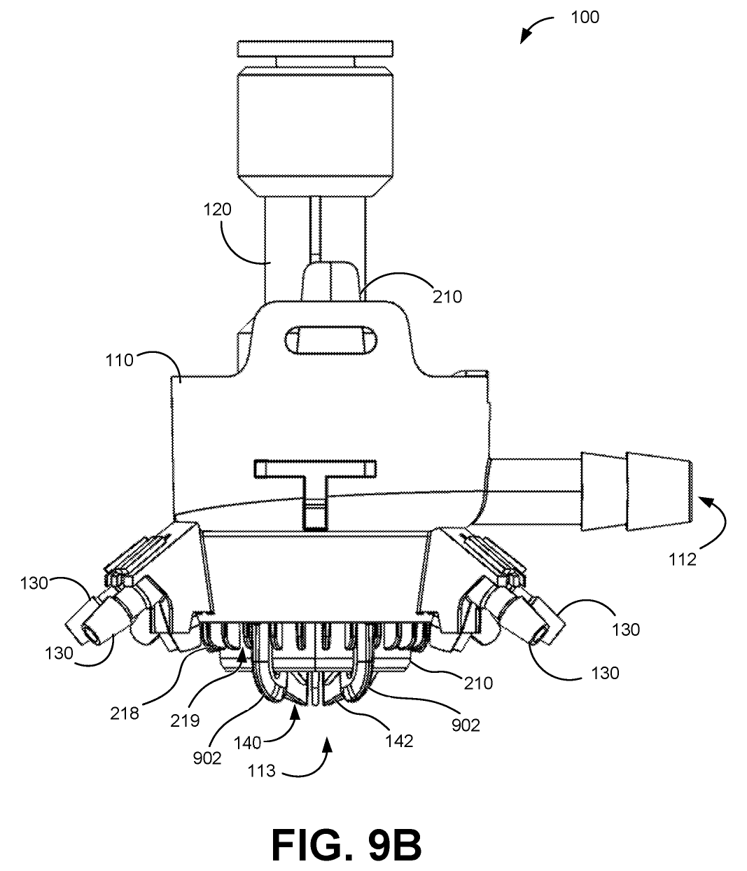

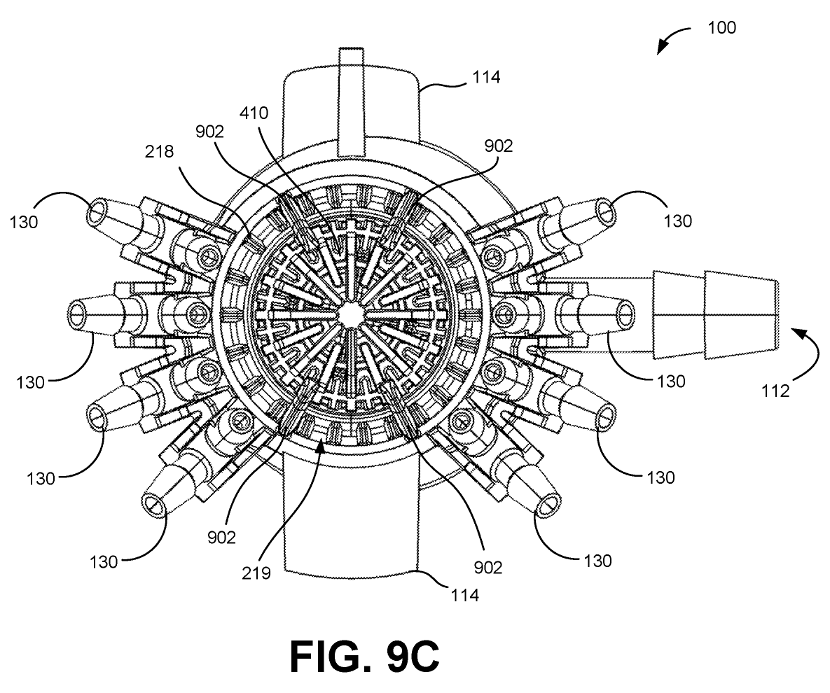

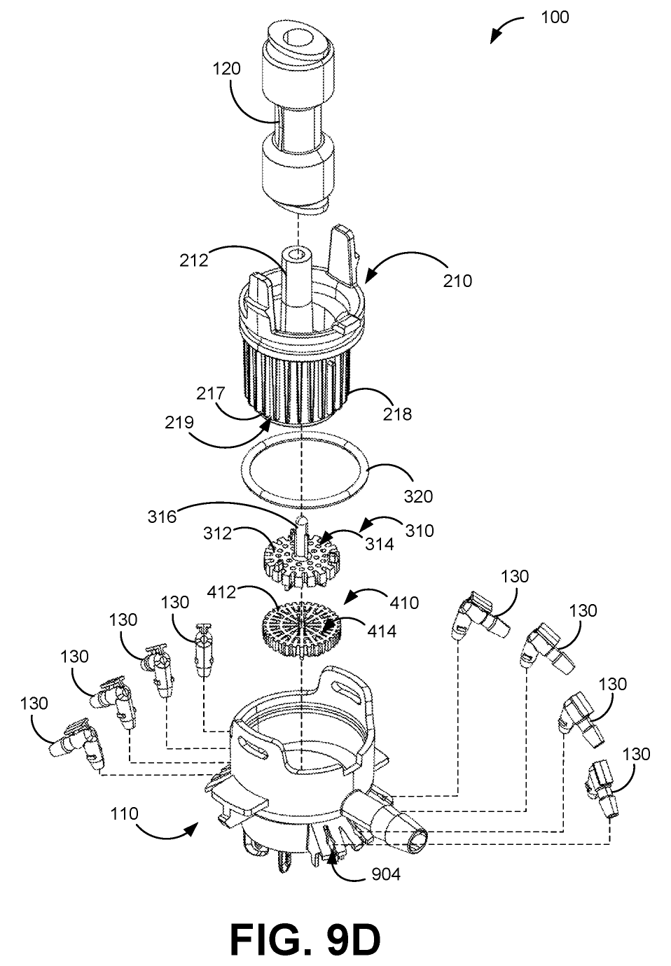

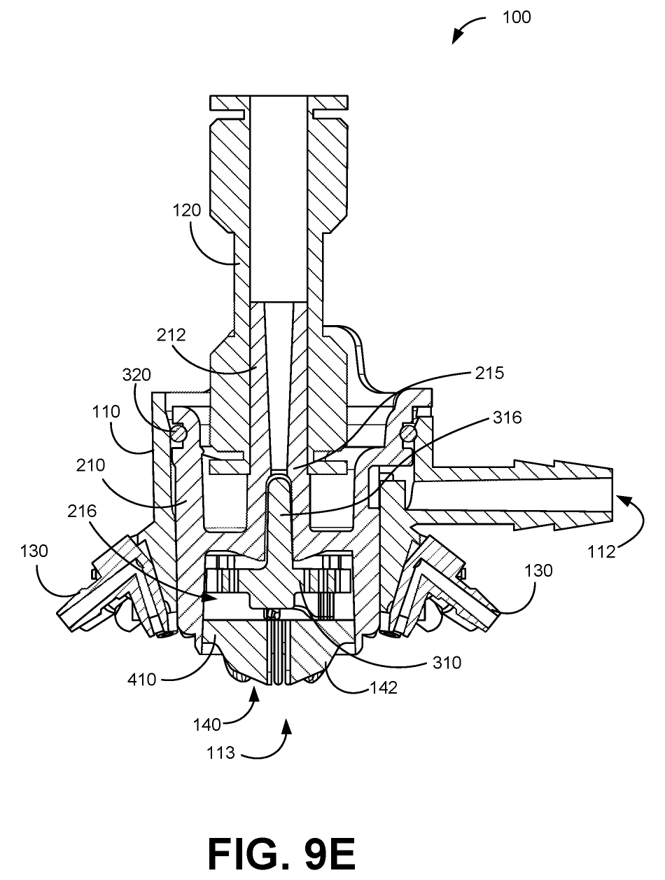

Referring now to FIGS. 9A–9E, various view of an example nozzle assembly 100 are shown. As discussed elsewhere herein, the nozzle assembly 100 can include the nozzle housing 110 and the screen assembly 200, which can be disposed at least partially within the interior portion 116 of the nozzle housing 110.

The nozzle housing 110 can include one or more support structures 902 having a first portion extending downwardly from a lower portion (e.g., bottom, lowermost portion) of the nozzle housing 110 and a second portion extending radially inward (e.g., with respect to the central axis of the interior portion 116 of the nozzle housing 110) from the first portion. The support structures 902 can be configured to support and/or retain the screen assembly 200. For example, each support structure 902 (e.g., the first portion, the second portion) can be configured to abut one or more surfaces of the screen housing 210 and/or a lowermost screen (e.g., the second screen 410). Accordingly, at least a portion of the screen assembly 200 (e.g., at least a portion of the screen housing 210 and/or at least a portion of the second screen 410) can extend below a lowermost portion of the outer wall of the nozzle housing 110.

The nozzle housing 110 can omit the exit chamber 118 and/or the flow spreader 119. Alternatively or in addition, the flow stabilizer 140 can be attached to the screen assembly 200. For example, the flow stabilizer 140 can be attached to the screen housing 210. Alternatively or in addition, the flow stabilizer 140 can be attached to the lowermost screen (e.g., the second screen 410). Alternatively or in addition, the flow stabilizer 140 can be integral with the lowermost screen (e.g., the second screen 410). Stated differently, the second screen 410, as illustrated, can include a plurality of fins 142 extending from a bottom side of the body 412 of the second screen 410, and the fins 142 can at least partially define the flow stabilizer 140 on the bottom side of the second screen 410. The fins 142 can have a tapered, chamfered, and/or rounded profile. In any event, a given fin 142 can have a first length at a radially inward location (e.g., a radially innermost location) and a second length at a radially outward location (e.g., a radially outermost location). The first length can be greater than the second length such that the bottom surface of the fin 142 is directed toward a central vertical axis of the second screen 410 as the distance from the body 412 increases. The radially innermost sides of the fins 142 can be offset a distance from the central vertical axis of the second screen 410. Accordingly, a generally vertical open space can be defined between the radially innermost sides of the various fins 142, which can help direct the fluid flow from the second screen 410 and/or the dispensing outlet 113 in a stable (e.g., laminar) and aesthetically pleasing fluid flow shape. The various fins 142 can have the same thickness. Alternatively or in addition, one or more fins 142 can have a thickness that is different from the thickness of one or more other fins 142. Alternatively or in addition, the various fins 142 can have the same length (e.g., same first length, same second length, and/or one or more same intermediate lengths). Alternatively or in addition, one or more fins 142 can have a length (e.g., first length, second length, one or more intermediate lengths) that is different from a corresponding length of one or more other fins 142. Alternatively or in addition, the various fins 142 can have the same width. Alternatively or in addition, one or more fins 142 can have a width that is different from the width of one or more other fins 142. Alternatively or in addition, the various fins 142 can have the same general profile (e.g., general cross-sectional shape). Alternatively or in addition, one or more fins 142 can have a general profile that is different from the general profile of one or more other fins 142. As illustrated, the flow stabilizer 140 can include first fins 142 of a first size and second fins 142 of a second size that is smaller (e.g., in at least one dimension) than the first fins 142, and the first fins 142 and second fins 142 can be arranged in an alternating pattern. This example arrangement is non-limiting, as alternative arrangements of fins 142 are within the scope of this disclosure.

In any event, the fins 142 of the bottom screen 410 (or another portion of the screen assembly 200) can encourage the flowing fluid to flow at, near, toward, or along the central vertical axis of the bottom screen 410 (and/or the central vertical axis of the screen assembly or any portion thereof, such as the central vertical axis of the screen housing 210).

Alternatively or in addition, the nozzle housing 110 can include a plurality of injector ports 904 (e.g., disposed on an outer wall of the nozzle housing 110). As shown perhaps most clearly by FIG. 9D, each additive injector 130 can be configured to detachably attach to a corresponding injector port 904. For example, the additive injectors 130 and injector ports 904 can be configured to connect together via a snap fit connection, a friction fit connection, or the like. Alternatively or in addition, the additive injectors 130 can be attached to the injector ports 904 via one or more fasteners, or any other attachment mechanism or configuration. The additive injectors 130 and/or the injector ports 904 can be positioned and/or angled such that the additive exiting the injector outlets 134 of the additive injectors 130 first interacts with (e.g., contacts) the fluid exiting the nozzle housing 110 and/or the screen assembly 200 at a location that is below the nozzle housing 110 and/or the screen assembly 200.

Turning now to FIG. 9E, the upper wall of the dispersion chamber 216 can have a gentle taper and/or curve in an upward direction (e.g., opposite from the as the radially outward distance from the mating cavity 214 increases. This design form can help prevent or eliminate cavitation that may otherwise occur at this location within the nozzle assembly 100. Cavitation can otherwise occur because fluid flowing through the annular space between the mating cavity 214 and the mating protrusion 316 can have a high velocity (e.g., 40 miles per hour or greater), whereas the velocity of the fluid flowing in the dispersion chamber 216, for example, can be much less (e.g., approximately 2 miles per hour). The gradual and/or gentle taper and/or curve can help prevent a sudden drop in the pressure of the fluid as it exits the mating cavity 214, thereby preventing or eliminating cavitation (e.g., at least at that particular location within the nozzle assembly 100).

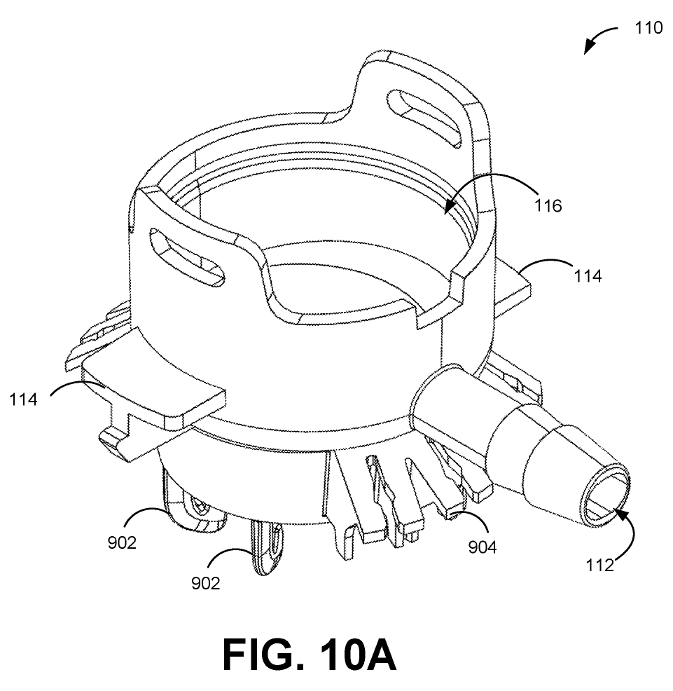

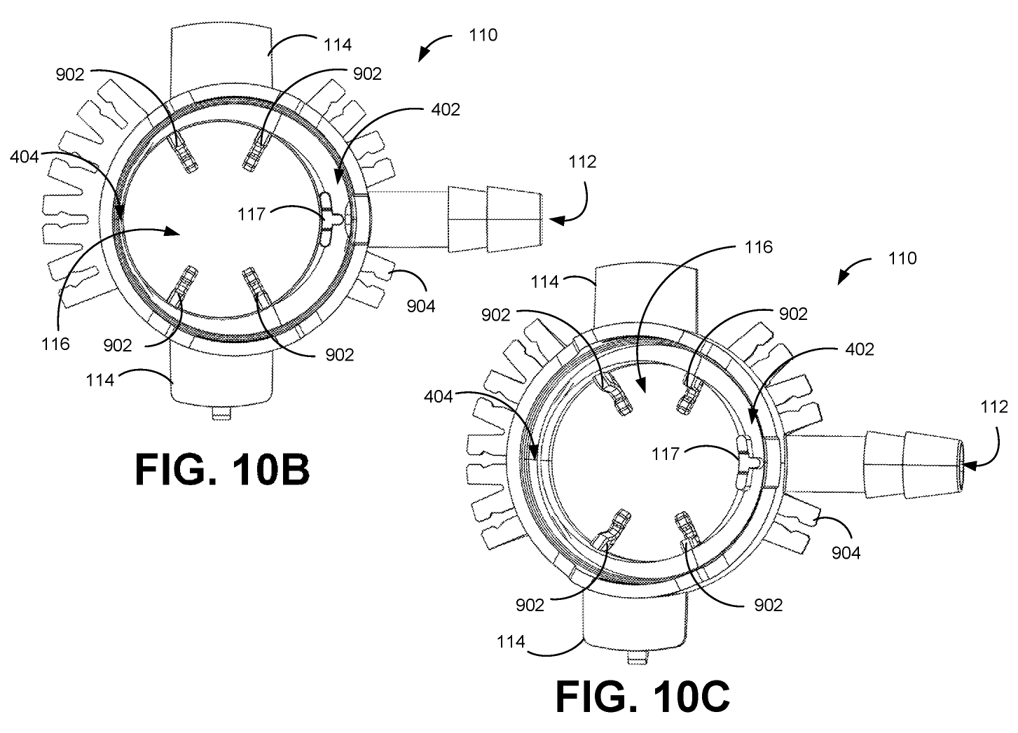

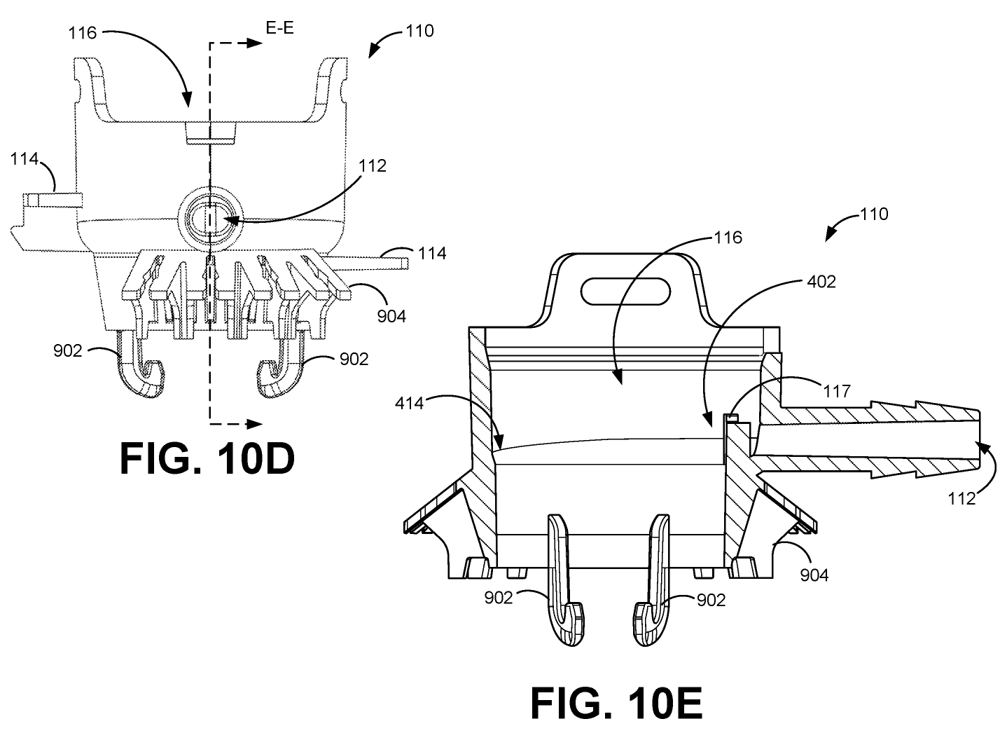

FIGS. 10A–10E show various views of the nozzle housing 110 omitting the exit chamber 118 and the flow spreader 119. Some or all of the other aspects and/or features of the nozzle housing 110 can remain in the same or similar manner as previously discussed herein. For example, the nozzle housing can include an eccentric cavity with the eccentric cavity front portion 402 being generally larger and more voluminous than the eccentric cavity rear portion 404.

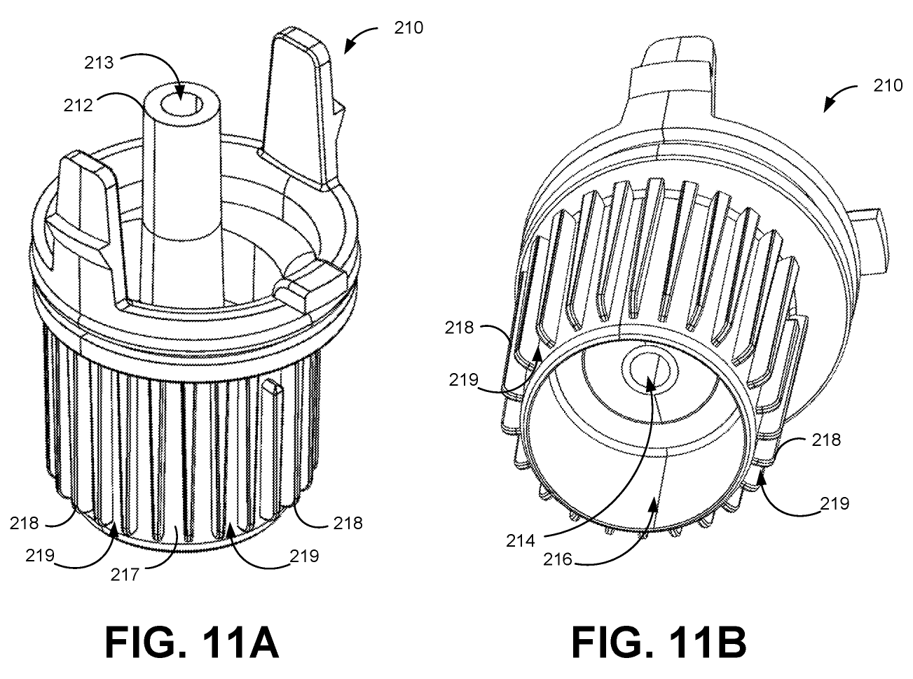

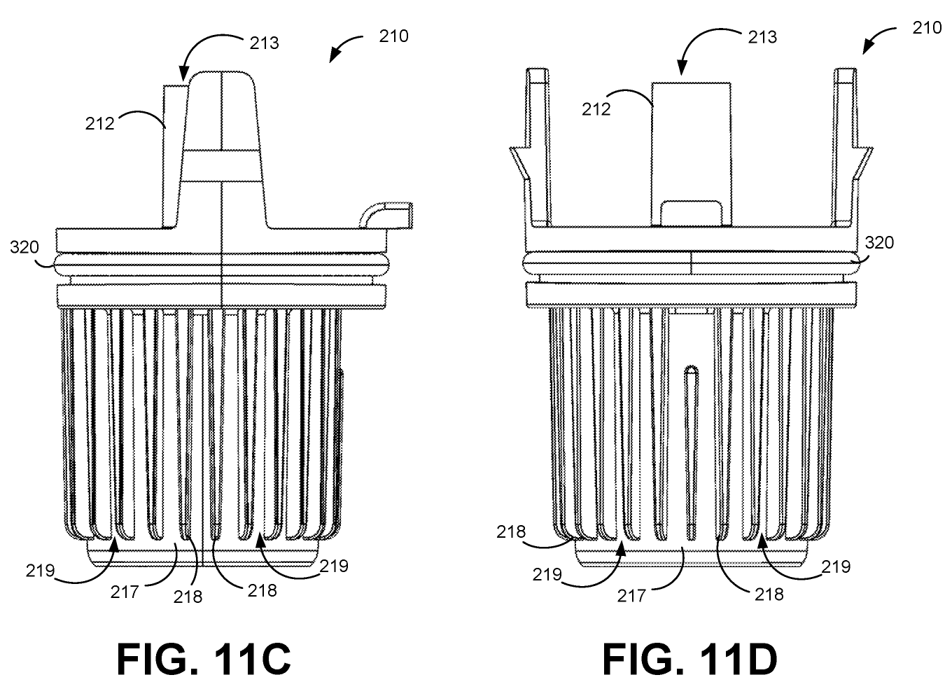

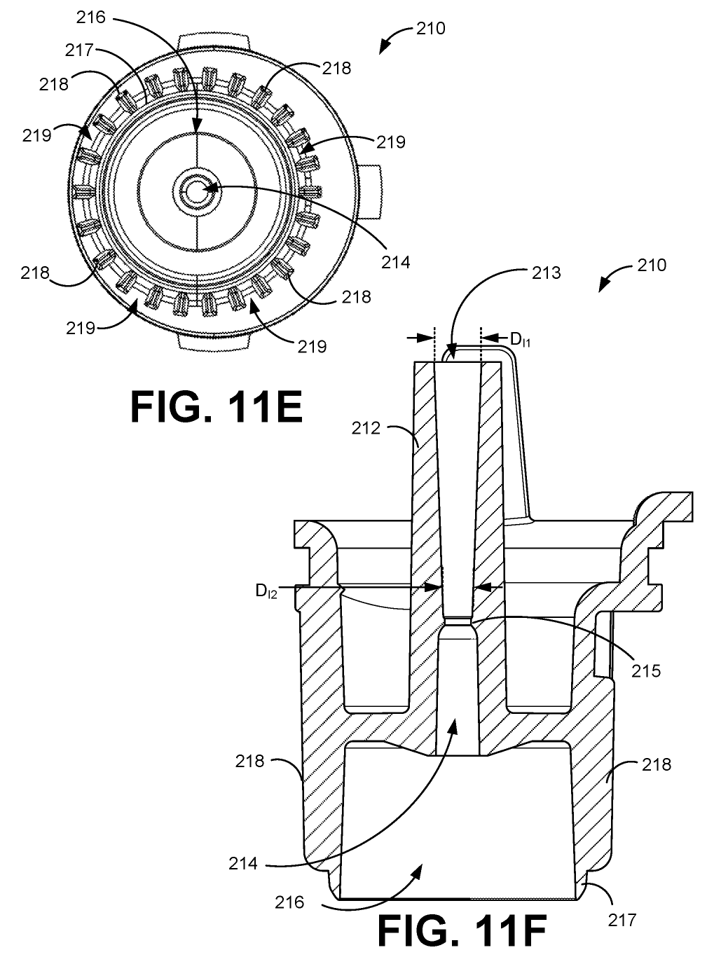

In a similar fashion, FIGS. 11A–11F show various views of the screen housing 210. Referring to FIG. 11F in particular, the inlet channel (e.g., located within the inlet stem 212, extending from the second inlet 213 and along at least a portion of the length of the inlet stem 212) can have a first diameter D_{I1} at or near the second inlet 213 and a second diameter D_{I2} at some location along the inlet channel that is closer to the mating cavity 214 that the second inlet 213. For example, the second diameter D_{I2}can correspond to a location along the inlet channel that is at or near (e.g., proximate) the annular protrusion 215 extending radially inward into the inlet channel. In any event, the second diameter D_{I2}canbe less than the first diameter D_{I1}, such that the inlet channel gradually tapers as the distance from the second inlet 213 increases.

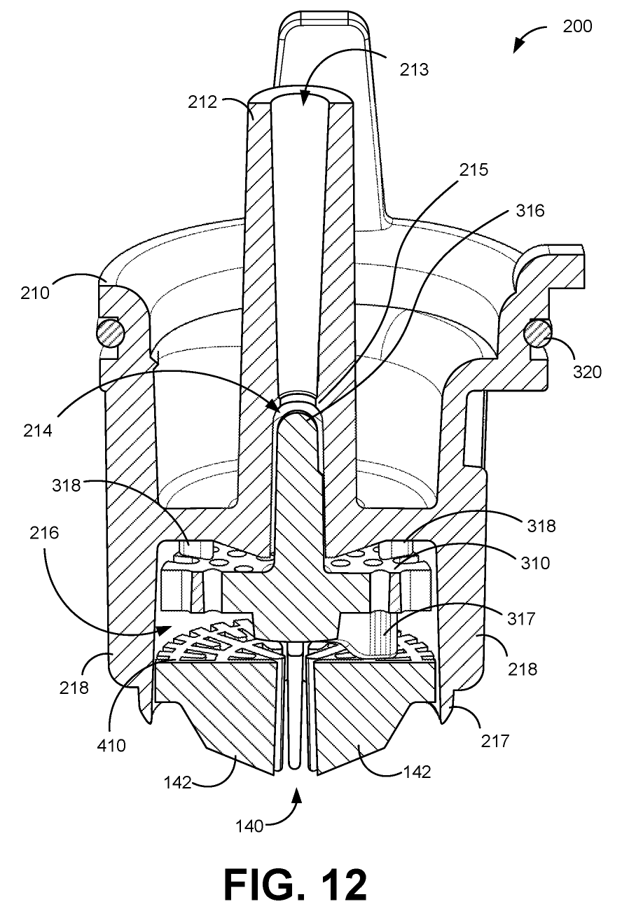

FIG. 12 illustrates a cross-sectional view of the screen assembly 200 with the second screen 410 including the flow stabilizer 140. Some or all of the other aspects and/or features of the screen assembly 200 can remain in the same or similar manner as previously discussed herein.

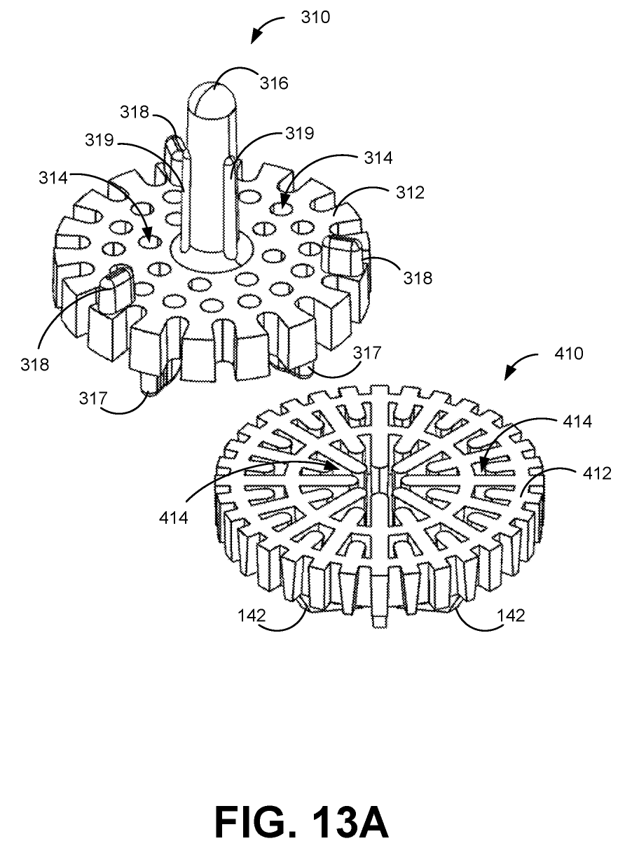

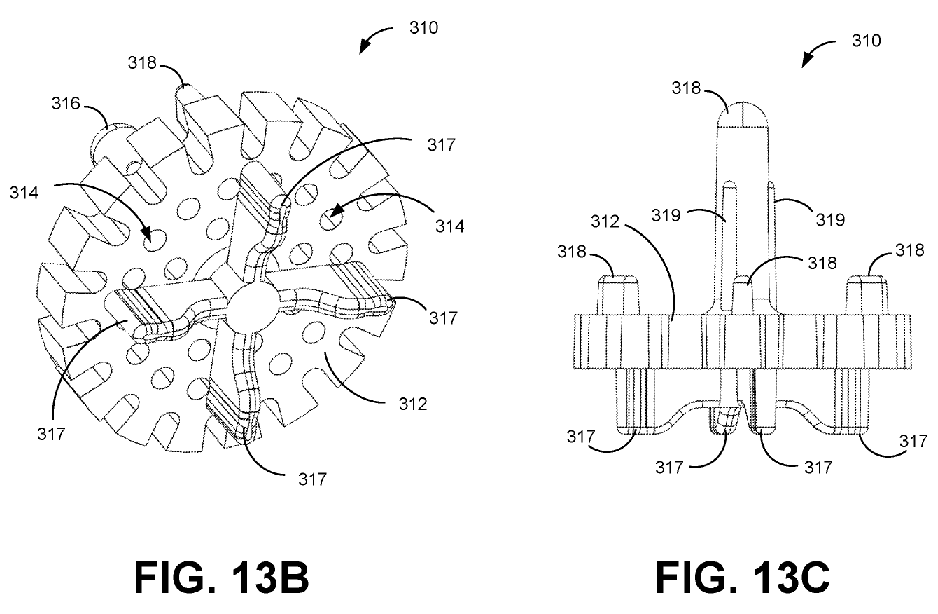

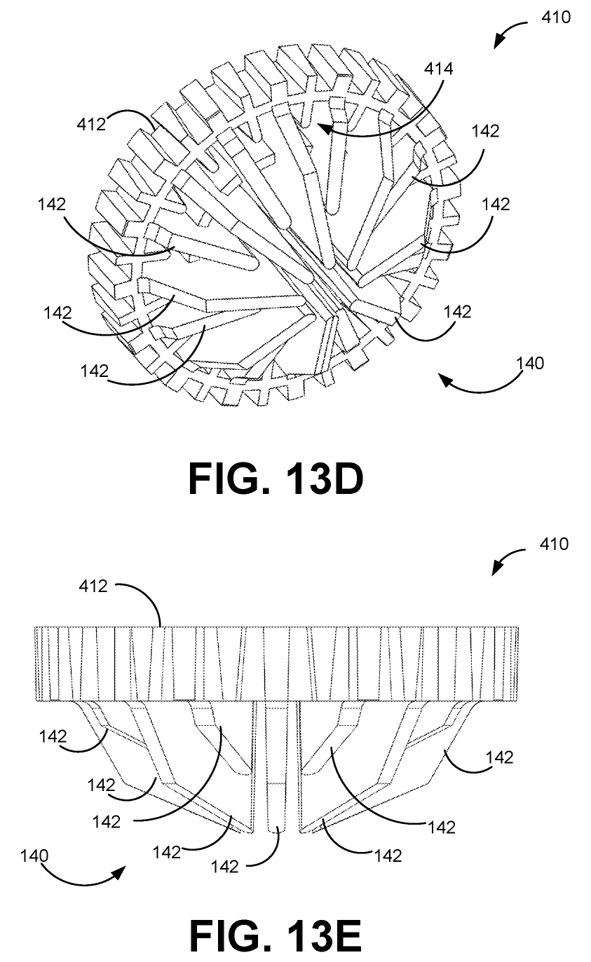

FIGS. 13A–13E illustrate various views of the first screen 310 and/or the second screen 410. The first screen 310 is depicted in the same or similar manner as previously shown and described herein. The second screen 410, however, is show as including the flow stabilizer 140. One or more fins 142 of the flow stabilizer 140 can extend from the bottom side and/or the bottom surface of the second screen 410. Alternatively or in addition, one or more of the fins 142 can extend downwardly from the top surface of the second screen 410. Alternatively or in addition, a given fin 142 can be separated from an adjacent fins 142 by an aperture 414 extending through the entire length or height of the second screen 410 and/or fins 142. Stated differently, the fins 142 can at least partially define the body 412 of the second screen 410, as shown perhaps most clearly by FIG. 13A. Alternatively or in addition to the fins 142, the body 412 can include one or more annular body portions (e.g., concentrically arranged) and/or one or more radial body portions. The radial body portions can each extend in a corresponding radial direction and can intersect one or more of the annular body portions. Alternatively or in addition, the annular body portions can intersect one, some, or all of the fins 142.

The first screen 310 and the second screen 410 can have the same outer diameter. Alternatively or in addition, the first screen 310 can have an outer diameter that is different from the outer diameter of the second screen 410. As a non-limiting example, the first screen 310 can have an outer diameter that is less than the outer diameter of the second screen 410.

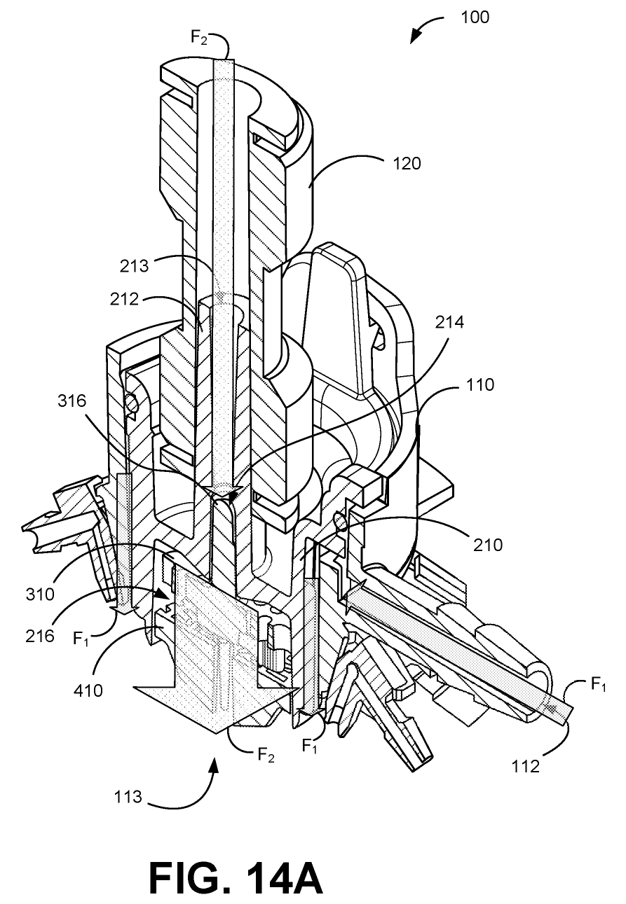

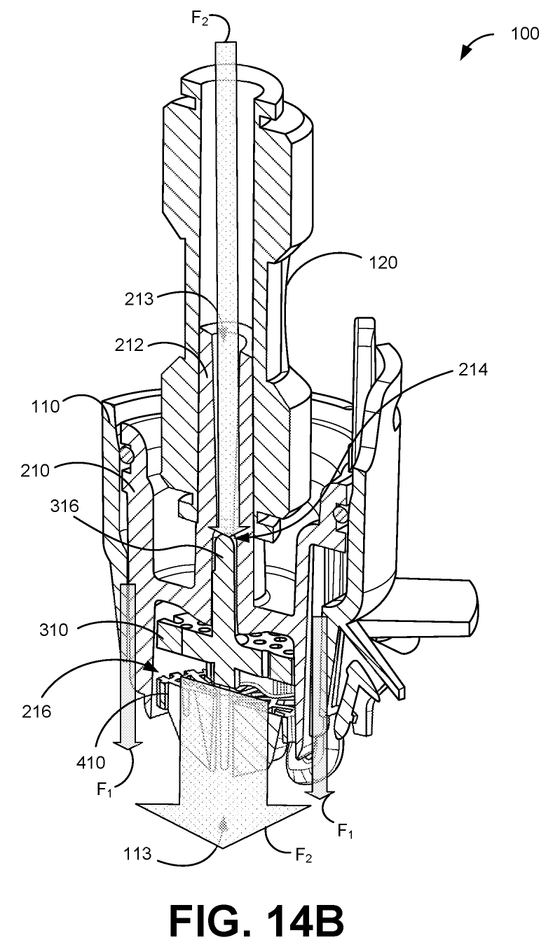

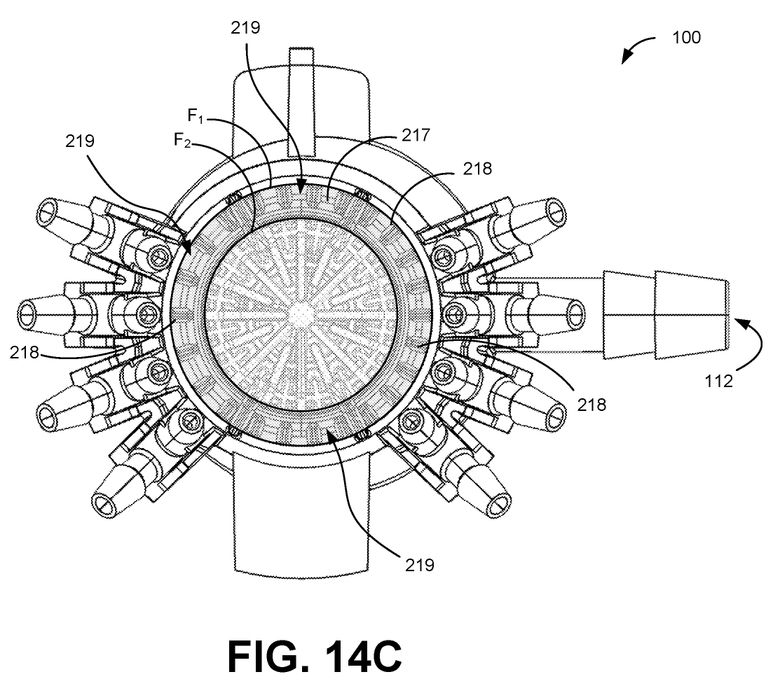

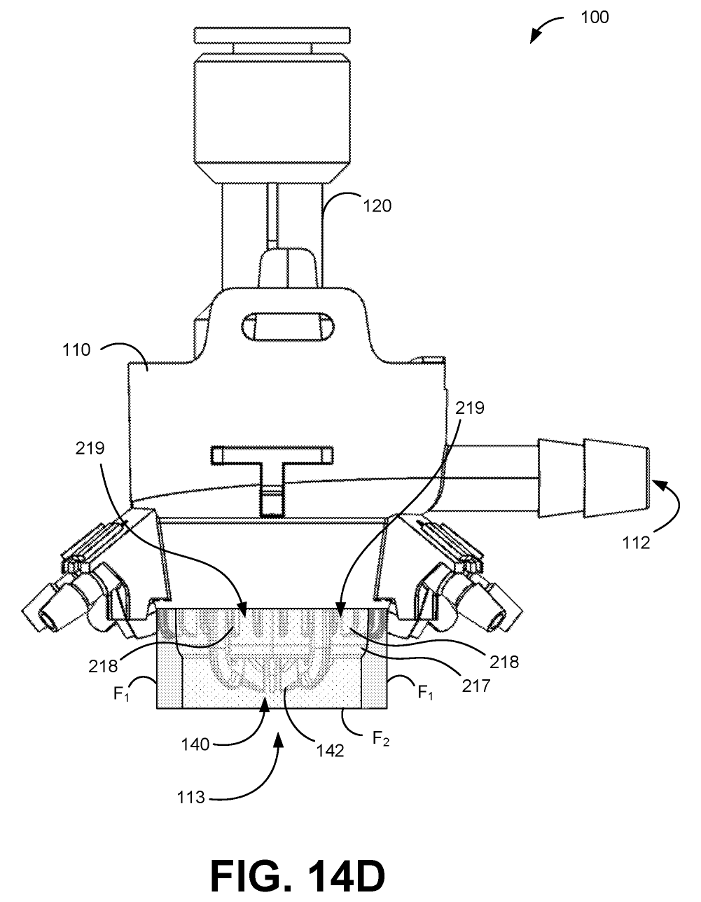

FIGS. 14A–14D illustrate the two fluidly isolated flow paths corresponding to a first fluid F₁ received via the first inlet 112 and a second fluid F₂ received via the second inlet 213. The first fluid F₁ can be received at the first inlet and directed toward the interior (e.g., the interior portion 116 and/or the eccentric cavity) of the nozzle housing 110, in which at least a portion of the screen housing 210 can be located. As the first fluid F₁ flows into the interior of the nozzle housing 110, the first fluid F₁ can contact the flow diverter 117, which can separate the generally unitary incoming stream of the first fluid F₁ into at least two flow paths extending from either generally circumferential direction from the flow diverter 117. The two or more flow paths of the first fluid F₁ can flow along the eccentric cavity front portion 402 towards the eccentric cavity rear portion 404. As the first fluid F₁ flows along the curved outer walls of the eccentric cavity, the first fluid F₁ can also contact the ribs 218 extending from the outer wall 217 of the screen housing 210 and/or can fall or flow downwardly through the channels 219 defined at least in part by the ribs 218, the outer wall 217, and/or one or more interior surfaces of the nozzle housing 110. The first fluid F₁ can exit the nozzle assembly in a generally annular shape, as shown perhaps most clearly by FIG. 14C. The first fluid F₁ can flow or roll off of the lower edge (e.g., the lowermost edge, which can be curved) of the outer wall 217 of the screen housing 210 and can then collapse centrally below the screen housing 210 (e.g., at or below the dispensing outlet 113).

Alternatively or in addition, the second fluid F₂ can enter the second inlet 213 and flow through the inlet channel of the inlet stem 212 until it contacts the annular protrusion 215 within the inlet channel and/or until it contacts the mating protrusion of the first screen 310, which can be located within the mating cavity 214 (which is fluidly connected to the inlet channel). The second fluid F₂ can flow along some or all of the length of the mating protrusion 316 in a generally annular shape (e.g., as determined by the gap between the mating protrusion 316 and the mating cavity 214. The second fluid F₂ can then flow or fall through the apertures 314 of the first screen and the apertures 414 of the second screen 410. Alternatively or in addition, the second fluid F₂ can flow along the fins 142 extending downwardly from the second screen 410, and the second fluid F₂ can flow in a generally cylindrical shape, which can be generally aligned with the center of the second screen 410.

Alternatively or in addition, the configurations of the first fluid F₁ flow path and the second fluid F₂ flow path can prevent backflow of one fluid type into the flow path within the nozzle assembly 100 for another fluid type. This can be particularly useful in scenarios where one flow path provides hot fluid (e.g., the first fluid F₁ flow path) and another flow path provides cold fluid (e.g., the second fluid F₂ flow path). For example, the first fluid F₁ flow path can be fluidly connected to a pump system, and the pump system can, under certain circumstances, provide a reverse-flow effect at or near the exit location of the first fluid F₁. Should the beverage dispensing device then be used to dispense the second fluid F₂ (which can be a cold fluid) while the first fluid F₁ is being sucked back through the first fluid F₁ flow path, the corresponding backflow scenario and the timing of the dispensing of the second fluid F₂ can result in some of the second fluid F₂ (e.g., a cold liquid) being sucked into at least a portion of the flow path within the nozzle assembly 100 for the first fluid F₁ (e.g., a hot liquid). The temperature difference between the two fluids can therefore negatively impact the quality of a subsequently dispensed beverage including the first fluid F₁.

This and other problems can be addressed and solved by various aspects of the nozzle assembly 100 shown and described herein. For example, the vertical and radial separations between the fluid exit locations of the first fluid F₁ and the second fluid F₂, the fins 142 extending from the second screen 410, and/or other features or aspects of the disclosed technology can prevent any dispensing second fluid F₂ from backflowing (e.g., being sucked into) the flow path within the nozzle assembly 100 for the first fluid F₁ while the first fluid F₁ is experience a backflow scenario.

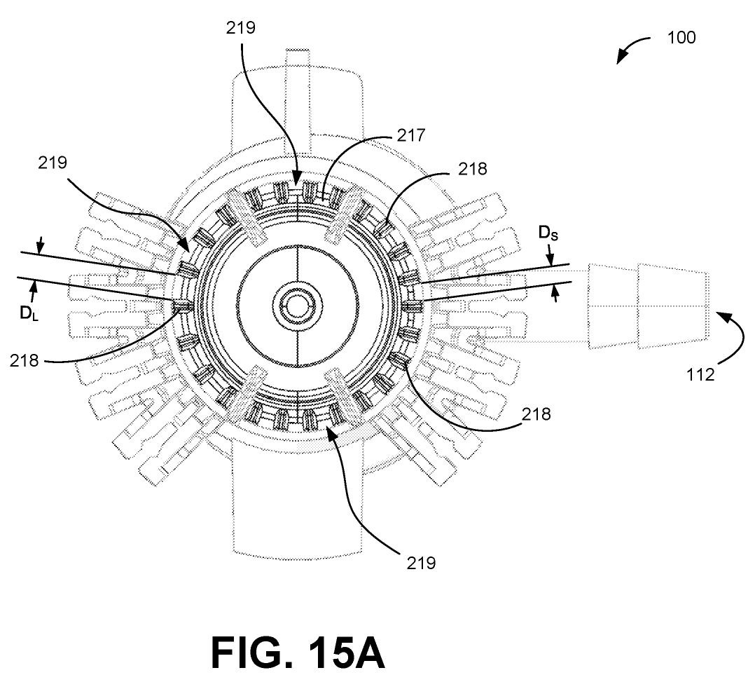

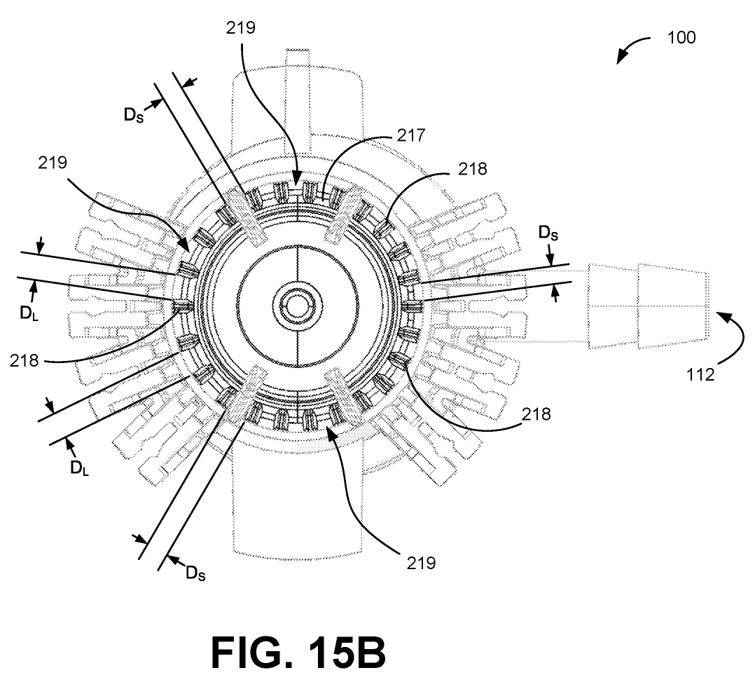

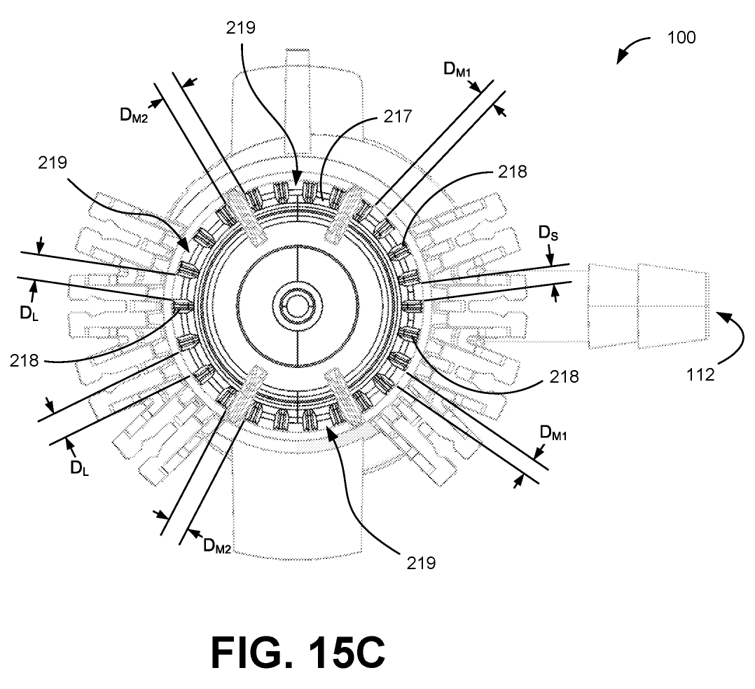

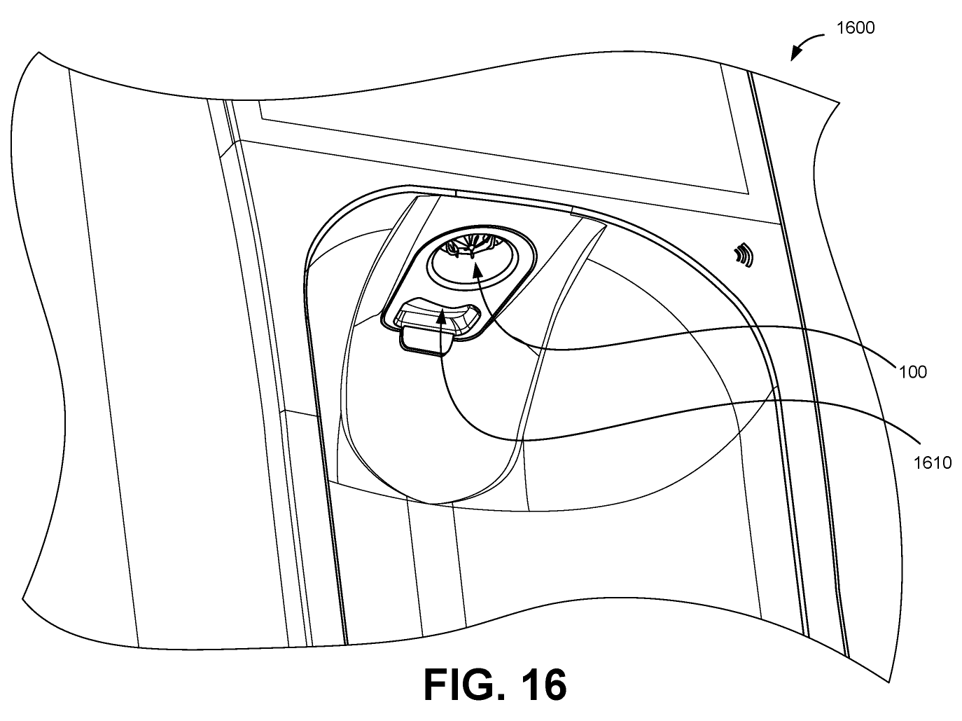

Turning now to FIGS. 15A–15C, the screen housing 210 is further discussed. Some or all of the ribs 218 extending from the outer wall 217 of the screen housing 210 can be equidistantly spaced. Stated differently, the distance or gap between adjacent pairs of ribs 218 can be the same for every adjacent pair of ribs 218. Alternatively or in addition, one, some, or all of the adjacent pairs of ribs 218 can have a separation distance or gap that is different in size (e.g., linear length, arc length) from that of one or more other adjacent pairs of ribs 218. Now referring specifically to FIG. 15A, and as a non-limiting example, one or more pairs of adjacent ribs 218 located at or near the eccentric cavity front portion 402 (e.g., at or near the same side of the nozzle assembly as the first inlet 112) can have a smaller and/or smallest distance D_{S} (e.g., linear length, arc length) therebetween as compared to a larger and/or largest distance D_{L} extending between one or more pairs of adjacent ribs 218 located on the side of the nozzle assembly opposite from the first inlet 112 (e.g., at or near the eccentric cavity rear portion 404).

Now referring specifically to FIG. 15B, and as a non-limiting example, a first portion of the circumference of the screen housing 210 (e.g., 20%, 25% 33%, 50%, 67%, 75%, 80%) can include (e.g., include only) pairs of adjacent ribs 218 having the smaller distance D_{S} therebetween, and a second portion of the circumference of the screen housing 210 (e.g., 20%, 25% 33%, 50%, 67%, 75%, 80%) can include (e.g., include only) pairs of adjacent ribs 218 having the larger distance D_{L} extending therebetween. Alternatively or in addition, the screen housing 210 can include any number of intermediate portions of the circumference of the screen housing 210 each including (e.g., including only) pairs of adjacent ribs 218 having a corresponding intermediate distance (e.g., greater than the smaller/smallest distance D_{S} and less than the larger/largest distance D_{L}) therebetween, as generally illustrated by FIG. 15C. Alternatively or in addition, the distance between adjacent pairs of ribs 218 can gradually increase from the smallest distance D_{S}, to a first intermediate distance D_{M1}, to a second intermediate distance D_{M2}, and so on, until the largest distance D_{L} has been reached.

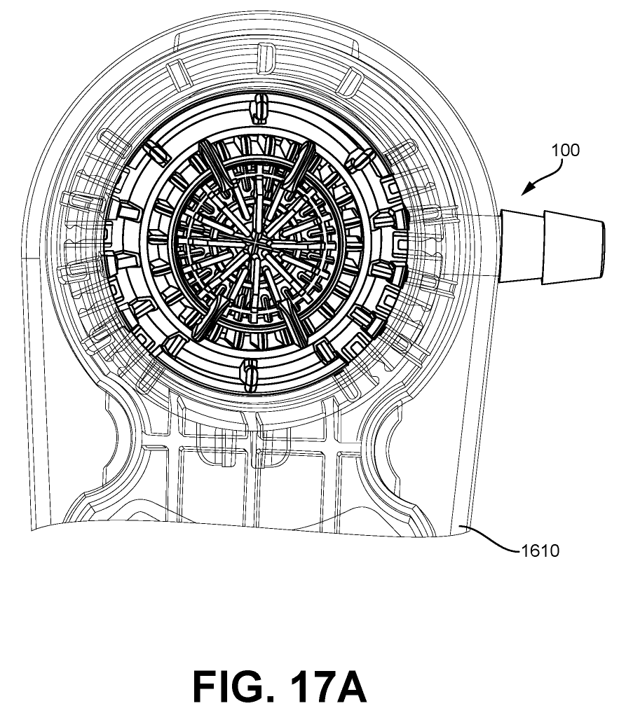

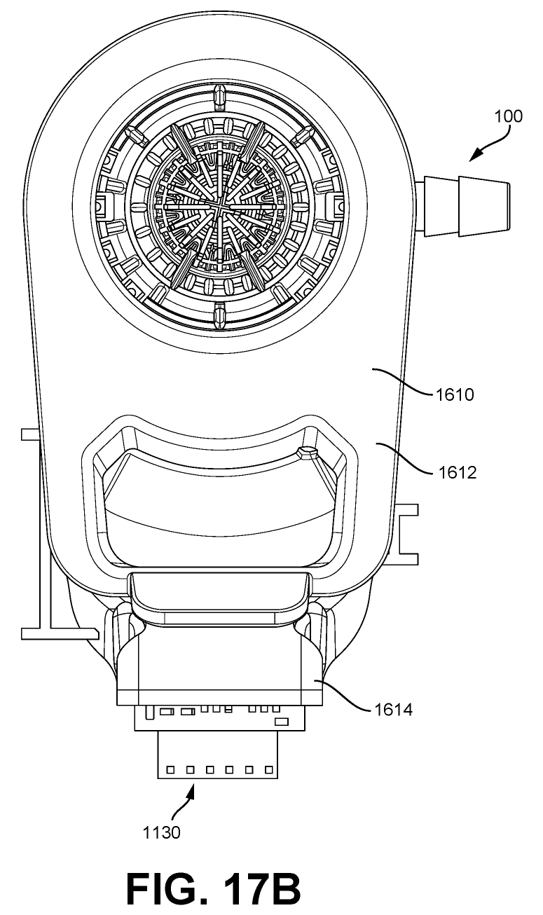

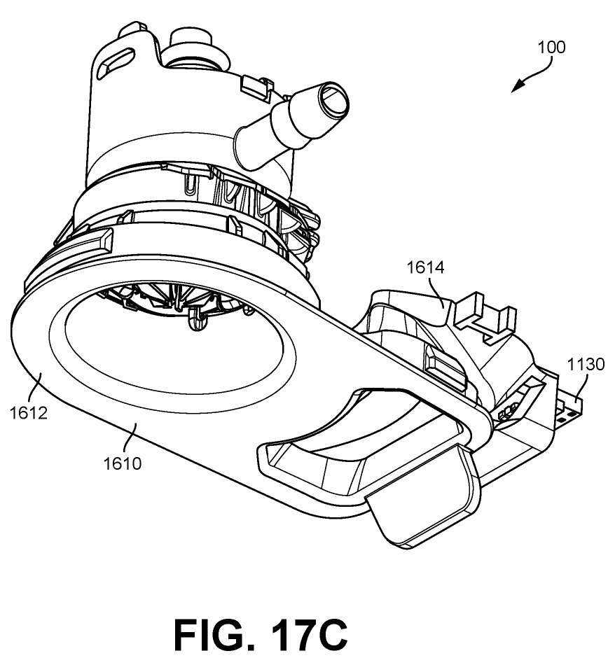

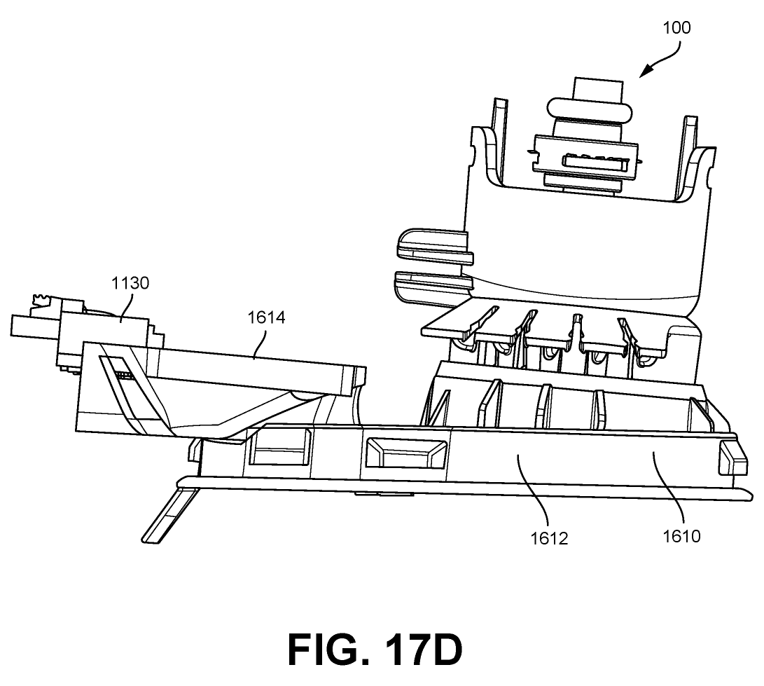

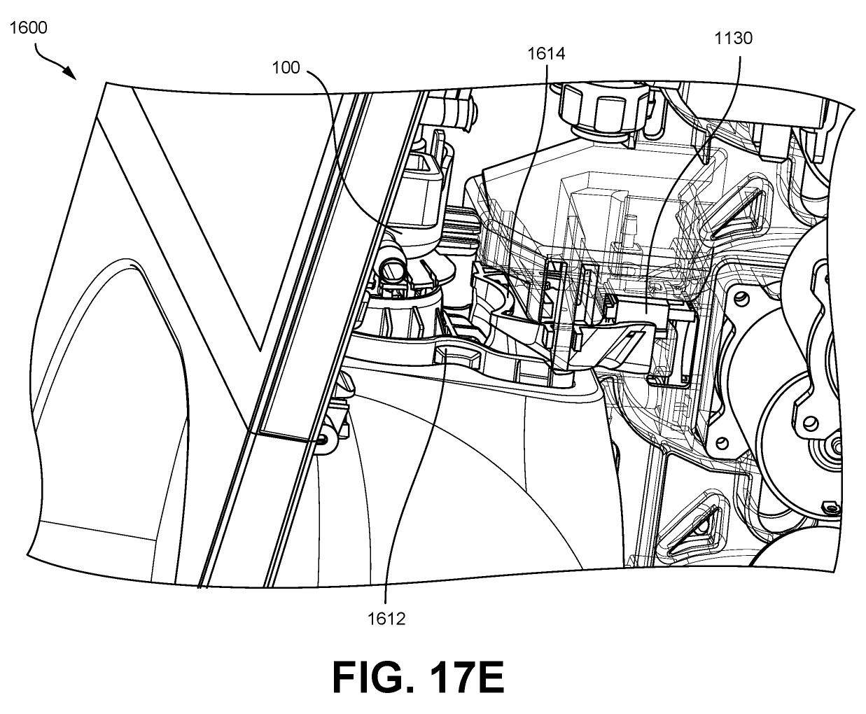

Referring now to FIGS. 16–17E, the disclosed technology can include a beverage dispensing device 1600, which can include the nozzle assembly 100 and a boot 1610. The boot 1610 can attach to the nozzle assembly 100 (e.g., to a lowermost portion of the nozzle assembly 100) and/or can be located immediately below the lowermost portion of the nozzle assembly 100. The boot 1610 (e.g., an inner perimeter of the boot 1610) can form a seal (e.g., a fluid-tight seal and/or an air-tight seal) with the nozzle assembly 100, as shown by FIG. 16, for example. Alternatively or in addition, the boot 1610 (e.g., an outer perimeter of the boot 1610 can attach to, and/or form a seal (e.g., a fluid-tight seal and/or an air-tight seal) with, the housing of the beverage dispensing device 1600. Accordingly, the boot 1610 can help prevent fluid (e.g., steam) from passing into, and/or accumulating within, the housing of the beverage dispensing device 1600 and/or on any internal components of the beverage dispensing device 1600. The boot 1610 can be manufactured from and/or comprise one or more plastics, one or more thermoplastics, one or more metals, or generally any material suitable for use in a beverage dispensing machine (e.g., a low surface energy (LSE) material), or any combination thereof.

The inner perimeter of the boot 1610 and/or the lowermost portion of the nozzle assembly 100 can at least partially define dispensing outlet 113 of the beverage dispensing device 1600 (e.g., where fluid is dispensed into a cup, container, or the like). Alternatively or in addition, the diameter and/or width of the inner perimeter of the boot 1610 can be equal to, or approximately equal to, the width or diameter (e.g., width or diameter W₂) of the nozzle assembly 100, which can further assist in preventing any steam (e.g., corresponding to the fluid exiting the nozzle assembly 100) from sticking to the beverage dispensing device 1600.

The boot 1610 can be a single, unitary piece or component. Alternatively or in addition, the boot 1610 can comprise multiple portions attached or connected to one another. For example, as illustrated, the boot 1610 can include a first portion 1612 (e.g., configured to form one or more seals with the nozzle assembly 100 and/or the housing of the beverage dispensing device 1600) and a second portion 1614 configured to attached to one or more internal components or structures within the housing of the beverage dispensing device 1600. Such a configuration can help facilitate easy attachment and/or detachment of the boot 1610 or other components (e.g., the nozzle assembly 100) from the beverage dispensing device 1600, such as for easy accessibility for cleaning, maintenance, or repair. Alternatively or in addition, and as shown perhaps most clearly in FIGS. 17D (a side view of the boot 1610 and corresponding components) and 17E (a perspective view of the boot 1610 in relation to example internal components of the dispensing devices, with some components removed or shown as transparent for illustrative purposes), the boot 1610 (e.g., the second portion 1614) can support or at least partially contain one or more sensors of the beverage dispensing device 1600 (e.g., liquid sensor, hygrometer, capacitive sensor) and/or one or more connectors (e.g., for the sensor(s)).

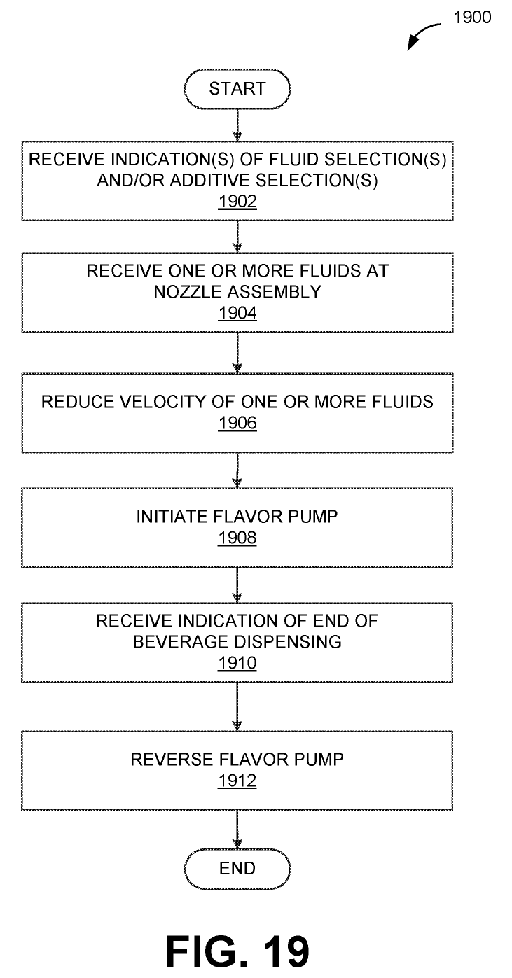

In one example, FIG. 19 illustrates a flowchart of an example beverage dispensing process 1900. The process 1900 can be performed by a beverage dispensing machine (e.g., the beverage dispensing device 1600). More specifically, the process 1900 can be performed in whole or in part by a controller of the beverage dispensing device (e.g., the controller 150). As non-limiting examples, the controller can include a processor, a microcontroller, a database, a graphical user interface (GUI), and/or other computing components, and the controller can be operatively connected to one or more additive pumps (e.g., a peristaltic pump).

At step 1902, the process 1900 can include receiving (e.g., by the controller 150) an indication of one or more additive (e.g., flavor) selections and one or more fluid selection (e.g., hot, cold, still, carbonated). The indication of the selection(s) can correspond to one or more user inputs and/or can include one or more signals received at the controller (e.g., in response to a user interacting with the GUI). Alternatively or in addition, step 1902 can include outputting instructions (e.g., by the controller 150, based at least in part on the user input(s) and/or sensor data from one or more sensors of the beverage dispensing device) to one or more components of the beverage dispensing device to cause one or more fluids to flow (e.g., from one or more fluid sources 152) toward a nozzle of the beverage dispensing device (e.g., the nozzle assembly 100) and/or one or more additives to flow (e.g., from one or more additive sources 154) toward to the nozzle. Actuation of fluid and/or additive pumping can be in response to mechanical and/or electrical inputs.

At step 1904, the process 1900 can include receiving the fluid(s) (e.g., as selected by the user) at the nozzle. Stated differently, step 1904 can include guiding the fluid(s) to and/or into the nozzle. As a non-limiting example, a first fluid can be received at a first inlet (e.g., the first inlet 112) of the nozzle (e.g., if the user-selected fluid is a hot fluid), and/or a second fluid can be received at a second inlet (e.g., the second inlet 213) of the nozzle (e.g., if the user-selected fluid is a cold fluid, whether still or sparkling). Regardless of the particular fluid type selected, the corresponding fluid flow can be initiated by the controller sending one or more signals to one or more components (e.g., pumps, valves) associated with the user-selected fluid.

At step 1906, the process 1900 can include reducing the velocity of the user-selected fluid(s). For example, step 1906 can include guiding the flowing fluid(s) through the nozzle to reduce the fluid velocity (e.g., via one or more components, one or more features, one or shapes, and/or one or more sizes of the nozzle assembly 100). For example, step 1906 can include guiding the flow of selected fluid(s) into contact with a plurality of stacked screens (e.g., first screen 310, second screen 410) to thereby reduce the velocity of the selected fluid(s) (e.g., one or more selected cold fluids). Alternatively or in addition, step 1906 can include guiding the flow of selected fluid(s) into contact with and/or through an eccentric chamber (e.g., the eccentric chamber or cavity of the nozzle housing 110), a plurality of ribs (e.g., the ribs 218 of the screen housing 210), and/or a plurality of channels (e.g., the channels 219 of the screen housing 210) to thereby reduce the velocity of the selected fluid(s) (e.g., one or more selected hot fluids) via the eccentric chamber, the ribs, and/or the channels. Following step 1906, fluid that has passed through the stacked screens can begin to fall towards, and through, the bottom end of the nozzle (e.g., down and around the flow spreader 119, through the dispensing outlet 113).

At step 1908, the process 1900 can include initiating (e.g., via the controller 150) one or more additive pumps. For example, step 1908 can include transmitting instructions for one or more particular additive pumps to activate based at least in part on the user-inputted additive selection(s). The instructions can cause the additive pump(s) to push one or more additives toward the flow of fluid(s) at or near the bottom end of the nozzle (e.g., at or near the dispensing outlet 113, via one or more corresponding additive injectors 130).

At step 1910, the process 1900 can include receiving (e.g., at the controller 150, based at least in part on sensor data received from one or more sensors, based at least in part on a timer) an indication that beverage dispensing is to end. Alternatively or in addition, the indication that beverage dispensing is to end can be received in response to the user disengaging (e.g., ceasing interaction with) the GUI.

At step 1912, the process 1900 can include reversing the additive pump(s) (e.g., based at least in part on instructions transmitted from the controller 150). For example, step 1912 can include transmitting instructions and/or a signal to one or more corresponding additive pumps to reverse the pump direction of the one or more corresponding additive pumps. Reversing an additive pump can pull the additive toward the inlet of the additive injector (e.g., the injector inlet 132) and/or away from an upper bend of the additive injector (e.g., the injector apex 136), which can reduce (or eliminate) subsequent additive from exiting the additive injector (e.g., dripping). Such dripping could otherwise contaminate the fluid(s) of a subsequent dispensing event (e.g., a subsequent user’s drink) with an unselected additive (e.g., cross contamination, an additive unselected by the subsequent user). Alternatively or in addition, step 1912 can include executing (e.g., by the controller 150 and/or the additive pump(s)) a control sequence for ramping down, pausing, and/or ramping up in reverse.

### Conclusion

The disclosure herein can be carried out wholly or in part by a computing environment, which can include a server computer, or any other system providing computing capability. Alternatively, the computing environment may employ a plurality of computing devices that may be arranged, for example, in one or more server banks or computer banks or other arrangements. Such computing devices can be located in a single installation or may be distributed among many different geographical locations. For example, the computing environment can include a plurality of computing devices that together may include a hosted computing resource, a grid computing resource, and/or any other distributed computing arrangement. In some cases, the computing environment can correspond to an elastic computing resource where the allotted capacity of processing, network, storage, or other computing-related resources may vary over time.

Various applications and/or other functionality may be executed in the computing environment according to various embodiments. Also, various data is stored in a database that is accessible to the computing environment. The database can be representative of a plurality of databases as can be appreciated. The data stored in the database, for example, may be associated with the operation of the various applications and/or functional entities described herein.

The computing environment can communicate with a plurality of computing devices and querying devices (which may include computing devices) via a network. The network includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

Aspects, features, and benefits of the systems, methods, processes, formulations, apparatuses, and products discussed herein will become apparent from the information disclosed in the figures and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the figures or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the systems and processes to the precise forms disclosed. Many modifications and variations are possible in light of the above teaching.

The embodiments were chosen and described in order to explain the principles of the systems and processes and their practical application so as to enable others skilled in the art to utilize the systems and processes and various embodiments and with various modifications as are suited to the particular use contemplated. Alternative embodiments will become apparent to those skilled in the art to which the present systems and processes pertain without departing from their spirit and scope. Accordingly, the scope of the present systems and processes is defined by the appended claims rather than the foregoing description and the exemplary embodiments described therein.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hard-wired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems and processes may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed systems and processes are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems and processes are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the systems and processes is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems and processes will be readily discernible from the description herein, by those of ordinary skill in the art. Many embodiments and adaptations of the disclosure and claimed systems and processes other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems and processes. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems and processes. In addition, some steps may be carried out simultaneously, contemporaneously, or in synchronization with other steps.

The embodiments were chosen and described in order to explain the principles of the claimed systems and processes and their practical application so as to enable others skilled in the art to utilize the systems and processes and various embodiments and with various modifications as are suited to the particular use contemplated. Alternative embodiments will become apparent to those skilled in the art to which the claimed systems and processes pertain without departing from their spirit and scope. Accordingly, the scope of the claimed systems and processes is defined by the appended claims rather than the foregoing description and the exemplary embodiments described therein.

What is claimed is:

1. A beverage dispensing system comprising:
a housing;
a nozzle assembly attached to the housing, the nozzle assembly being in fluid communication with a first fluid source comprising a first fluid, a second fluid source comprising a second fluid, and one or more additive sources comprising one or more additives, the nozzle assembly comprising:
a nozzle housing comprising:
a first outer wall defining an interior portion; and
a first inlet in fluid communication with the interior portion and the first fluid source; and
a screen housing located at least partially within the interior portion, the screen housing comprising:
a second outer wall at least partially defining a chamber within the screen housing, the second outer wall having one or more outer wall surfaces distanced apart from one or more inner wall surfaces of the nozzle housing to thereby at least partially define one or more gaps;
a second inlet in fluid communication with the chamber and the second fluid source;
a first screen located at least partially within the chamber; and
a second screen located at least partially within the chamber at a side of the first screen that is opposite from the second inlet; and
one or more additive injectors in fluid communication with the one or more additive sources, the one or more additive injectors being configured to direct one or more additives toward a stream of the first fluid or the second fluid.

2. The beverage dispensing system of claim 1, wherein:
a first fluid flow path is defined at least in part by the first inlet, the interior portion, and the one or more gaps;
a second fluid flow path is defined at least in part by the second inlet, the plurality of first apertures, and the plurality of second apertures; and
the second fluid flow path is fluidly isolated from the first fluid flow path.

3. The beverage dispensing system of claim 1, further comprising a fluid distribution system comprising one or more pumps configured to selectively direct the first fluid from the first fluid source to the first inlet, the second fluid from the second fluid source to the second inlet, and the one or more additives from the one or more additive sources to the one or more additive injectors.

4. The beverage dispensing system of claim 3, wherein the first fluid is heated and the second fluid is unheated.

5. The beverage dispensing system of claim 1, wherein the second outer wall of the screen housing extends outwardly from a bottom of the first outer wall of the nozzle housing.

6. The beverage dispensing system of claim 1, further comprising a boot forming a first seal with the nozzle housing and a second seal with a nozzle aperture of the housing.

7. A nozzle assembly comprising:
a first inlet and a second inlet;
a nozzle housing comprising:
a first outer wall defining an interior portion, the first inlet being in fluid communication with the interior portion; and
an eccentric cavity having a concave wall as viewed from within the interior portion;
a screen assembly disposed at least partially within the interior portion of the nozzle housing, the screen assembly comprising:
a screen housing having a second outer wall defining a chamber, the second inlet being in fluid communication with the chamber, and one or more outer surfaces of the second outer wall being radially spaced apart from one or more inner surfaces of the interior portion to thereby provide one or more channels fluidly connected to a first outlet;
a plurality of stacked screens, each being at least partially disposed within the chamber, the plurality of screens comprising:
a first screen; and
a second screen; and
a second outlet.

8. The nozzle assembly of claim 7, wherein:
the screen housing comprises a chamber ceiling and a chamber inlet extending through the chamber ceiling;
the chamber ceiling has a first height at a perimeter of the chamber inlet and a second height at a position radially outward from the perimeter of the chamber inlet, the second height being greater than the first height; and
the chamber ceiling tapers from the first height to the second height.

9. The nozzle assembly or claim 7, wherein:
the first inlet is in fluid communication with the eccentric cavity, the eccentric cavity is in fluid communication with the one or more channels, and the one or more channels is in fluid communication with the first outlet to thereby provide a first fluid flow path;
the second inlet is in fluid communication with the first plurality of apertures, the first plurality of apertures is in fluid communication with the second plurality of apertures, and the second plurality of apertures is in fluid communication with the second outlet to thereby provide a second fluid flow path; and
the second fluid flow path is fluidly isolated from the first fluid flow path.

10. The nozzle assembly of claim 7, wherein a bottom portion of the screen assembly extends downwardly beyond a lowermost portion of the first outer wall of the nozzle housing.

11. The nozzle assembly of claim 9, wherein the first outlet has a generally annular shape and is defined by the lowermost portion of the first outer wall and an intermediate portion of the second outer wall.

12. The nozzle assembly of claim 10, wherein the lowermost portion of the second outer wall is configured to direct a first fluid from the first fluid flow path to flow off a lowermost, curved edge of the second outer wall after the first fluid exits the first outlet, thereby causing a flow of the first fluid to collapse centrally below the chamber of the screen housing.

13. The nozzle assembly of claim 7, wherein the screen housing further comprises a plurality of ribs extending outwardly from the second outer wall, the plurality of ribs at least partially defining the one or more channels.

14. The nozzle assembly of claim 12, wherein at least one of the one or more channels has first width that is different from a second width of at least one other of the one or more channels.

15. The nozzle assembly of claim 13, wherein:
the first inlet is located at a first side of the nozzle assembly;
at least some of the one or more channels having the first width are located at a first side of the screen housing that corresponds to the first side of the nozzle assembly; and
at least some of the one or more channels having the second width are located at a second side of the screen housing that is opposite from the first side of the screen housing.

16. The nozzle assembly of claim 7, wherein:
the first inlet is located at a first side of the nozzle housing;
a first portion of the eccentric cavity has a first radial width, the first portion of the eccentric cavity being located at the first side of the nozzle housing;
a second portion of the eccentric cavity has a second radial width, the second portion of the eccentric cavity being located at a second side of the nozzle housing that is opposite from the first side; and
the second radial width is less than the first radial width.

17. The nozzle assembly of claim 7, further comprising a plurality of fins extending from the second screen.

18. The nozzle assembly of claim 16, wherein each fin of the plurality of fins has a generally tapered profile.

19. The nozzle assembly of claim 16, wherein each fin of the plurality of fins has a radially innermost point that is spaced apart from a central, generally vertical axis of the second screen.

20. The nozzle assembly of claim 7, further comprising a plurality of additive injectors, each of the plurality of additive injectors (i) having a first injector portion extending from an injector inlet to a bend, and a second injector portion extending from the bend to an injector outlet, and (ii) being attached to the nozzle assembly such that the bend corresponds to an apex of an injector fluid path extending along the first injector portion and the second injector portion.

21. A method comprising:
receiving one or more user inputs indicative of a fluid type selection and an additive type selection;
in response to the one or more user inputs indicating selection of a first fluid, directing the first fluid to flow through a first fluid path of a nozzle assembly, the first fluid path comprising:
an eccentric cavity located along a perimeter of an interior portion of a nozzle housing of the nozzle assembly;
a plurality of ribs protruding radially outward toward the eccentric cavity and defining a plurality of channels extending at least partially in a vertical direction;
the plurality of channels; and
a first outlet having a generally annular shape;
in response to the one or more user inputs indicated selection of a second fluid, directing the second fluid to flow through a second fluid path of the nozzle assembly, the second fluid path comprising:
an inlet channel extending through a generally vertical inlet stem;
a generally annular cavity flow path defined at least in part by a longitudinal cavity and a longitudinal protrusion extending generally upward therein;
a plurality of first apertures extending through a first body of a first screen;
a plurality of second apertures extending through a second body of a second screen; and
a second outlet located within the generally annular shape of the first outlet; and
directing one or more additives indicated by the one or more user inputs to inject into the first fluid as the first fluid exits the first outlet or into the second fluid as the second fluid exits the second outlet.

22. The method of claim 21, further comprising: creating a reverse flow of the one or more additives to move at least some of the one or more additives away from one or more corresponding additive outlets and past a local apex of each of one or more corresponding additive flow paths.
